(19) United States
(12) Patent Application Publication
(10) Pub. No.: US 2008/0140473 A1
(43) Pub. Date: Jun. 12, 2008

(54) System and method for determining composite indicators

(75) Inventor: Charles Taylor, Washington, DC (US)

Correspondence Address: RATNERPRESTIA, P O BOX 980, VALLEY FORGE, PA, 19482-0980, US

(73) Assignee: THE RISK MANAGEMENT ASSOCIATION

(21) Appl. No.: 11/636,003

(22) Filed: Dec. 8, 2006

(51) Int. Cl. G06Q 99/00

(52) U.S. Cl. 705/7

(57) ABSTRACT

A method for determining a composite indicator value associated with a number of indicators. Indicator representations, each associated with an indicator and based on its indicator values, are determined. A current indicator value is provided for each indicator. A T-value function associated with each indicator representation is established. Each T-value function is a continuous function of the associated indicator having: a first T-value for indicator values in a first range of the associated indicator representation; a third T-value equal to or greater than a minimum value for indicator values in a third range of the associated indicator representation; and a second T-value for indicator values in a second range of the associated indicator representation that varies monotonically between the first and third range values. Current T-values corresponding to the current indicator values are calculated using the associated T-value functions. These current T-values are combined to calculate the composite indicator value.

### FIELD OF THE INVENTION

The present invention generally relates to a method of determining composite indicators from diverse indicator representations based on various indicators of an organization, and more particularly, this method may be used to determine composite risk indicators that allow for the efficient disclosure of potential operational risks.

### BACKGROUND OF THE INVENTION

Quantitative measures, indicators, or indices of performance are commonly recorded and tracked in businesses and organizations. In many organizations and processes, these indices come in many different forms, scales, and kinds. This multitude of information can be difficult to combine and/or difficult to use for extracting the “key” values that management (or any central control) might find useful.

One context in which this problem arises is the management of operational risk in large financial institutions. In this context, so-called “key risk indicators” are a common way of monitoring risk at the operational level. Corporate operational risk managers have faced the problem for some time of determining how to extract useful decisionable information for reporting up to higher management levels, including senior management.

### SUMMARY OF THE INVENTION

An exemplary embodiment of the present invention is a method for determining a composite indicator value associated with a number of indicators. Each indicator has a number of indicator values. A number of indicator representations, each associated with one of the indicators and based on the indicator values of that indicator, are determined. Each indicator representation includes: at least one first range of indicator values; at least one second range of indicator values; and at least one third range of indicator values. Each first range is contiguous with at least one second range; each second range is contiguous with one first range and one third range; and each third range is contiguous with at least one second range. A current indicator value is provided for each of the plurality of indicators. A T-value function associated with each indicator representation is established. Each T-value function is a continuous function of the associated indicator having: a first constant T-value equal to a first range value for indicator values in the first range(s) of the associated indicator representation; a third T-value for indicator values in each third range of the associated indicator representation, the third T-value being equal to or greater than a minimum third range value; and a second variable T-value for indicator values in each second range of the associated indicator representation, the second variable T-value varying monotonically between the first range value and the minimum third range value. For each indicator, a current T-value corresponding to the current indicator value of the associated indicator is calculated using the associated T-value function. These current T-values are combined to calculate the composite indicator value.

Another exemplary embodiment of the present invention is a computer readable medium adapted to instruct a general purpose computer to calculate a composite indicator value associated with a number of indicators.

An additional exemplary embodiment of the present invention is an apparatus for determining a composite indicator value associated with a number of indicators.

A further exemplary embodiment of the present invention is a method of forming one or more composite indicator values for reporting on a number of indicators of an organization. A T-value function associated with each of the indicators is established. One or more reporting groups of the indicators are determined. Each reporting group is associated with one of the composite indicators. One or more sets of T-value functions are designated from the established T-value functions. Each set of T-value functions includes T-value functions associated with one reporting group of indicators. For each set of T-value functions, a relative intra-set weight of each T-value function in the set is determined. Each T-value function in the set is weighted by its determined relative intra-set weight and a base composite indicator value associated with the reporting group associated with the set is calculated using the weighted T-value functions of the set and indicator values of indicators of the reporting group. Sensitivity parameters associated with each reporting group are determined. For each reporting group, the composite indicator value is calculated based on the associated base composite indicator value and the associated sensitivity parameters.

### BRIEF DESCRIPTION OF THE DRAWING

The invention is best understood from the following detailed description when read in connection with the accompanying drawings. Included in the drawing are the following figures:

FIG. 1 is a flow chart illustrating an exemplary method of determining composite indicators from a number of underlying indicator representations according to the present invention;

FIGS. 2A, 2B, and 2C are graphs illustrating exemplary representations of key risk indicators (KRI's) that may be used as underlying indicator representations in exemplary methods according to the present invention;

FIGS. 3A and 3D are graphs illustrating exemplary T-value functions corresponding to the exemplary KRI representation of FIG. 2A transformed according to exemplary embodiments of the present invention;

FIGS. 3B and 3E are graphs illustrating exemplary T-value functions corresponding to the exemplary KRI representation of FIG. 2B transformed according to exemplary embodiments of the present invention;

FIG. 3C is a graph illustrating an exemplary T-value function corresponding to the exemplary KRI representation of FIG. 2C transformed according to an exemplary embodiment of the present invention;

FIG. 4 is a flow chart illustrating another exemplary method of determining composite indicators from a number of underlying indicator representations according to the present invention;

FIG. 5 is a flow chart illustrating another exemplary method of forming one or more composite indicators for reporting on a plurality of indicators of an organization according to the present invention; and

FIGS. 6, 7, 8, and 9 are graphs illustrating the calculation of exemplary composite indicator values from exemplary time series of T-values according to the exemplary method of FIG. 5.

### DETAILED DESCRIPTION OF THE INVENTION

In exemplary embodiments of the present invention, composite indices or indicators may be calculated as simple functions of a group of underlying variables, either weighted or unweighted. Such composite indices have proved durable and valuable in many aspects of economic life and in many aspects of engineering. The underlying reason for this durability is that any continuous multivariate partially differentiable function is approximately linear at any particular point, and, therefore, may be approximated by its tangent line or space over short ranges with some accuracy by a comparatively simple linear or multiplicative formula. In many exemplary methods of the present invention, the use of such approximations may lead to only a slight loss of generality, because these exemplary methods presuppose that the ranges of values of most interest are known (i.e. the defined ranges around thresholds). Additionally, the resulting simplification of the mathematical formulae used in the calculations allow for simplified understanding of the resulting composite indicators and indicator values, which may be desirable in many applications. One skilled in the art will understand that these approximations are used herein for illustrative purposes and are not intended to be limiting.

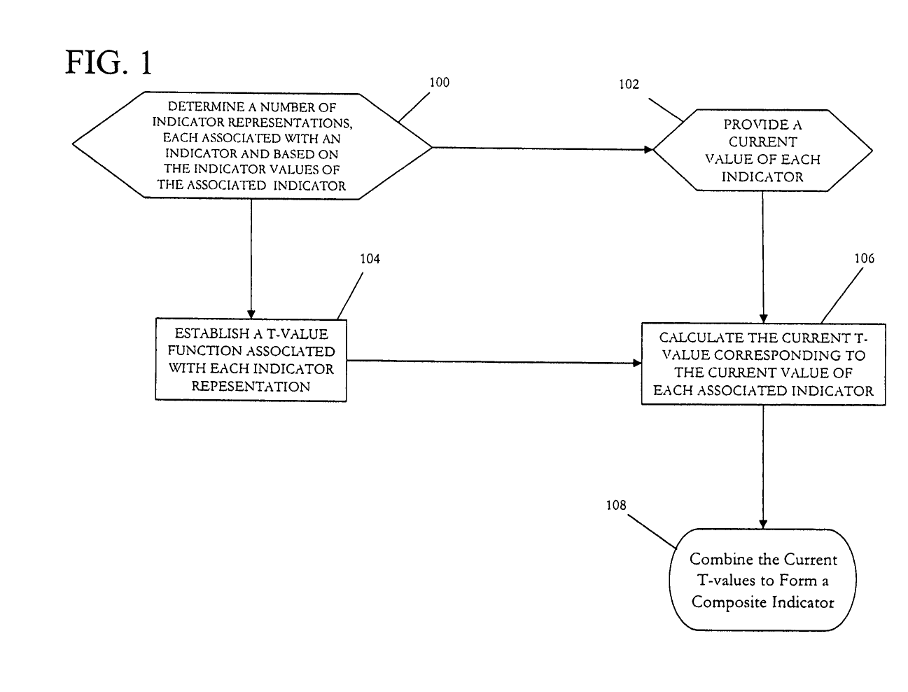

FIG. 1 illustrates an exemplary method for determining a composite indicator value associated with various disparate indicators that each use indicator values to quantitatively represent the indicator.

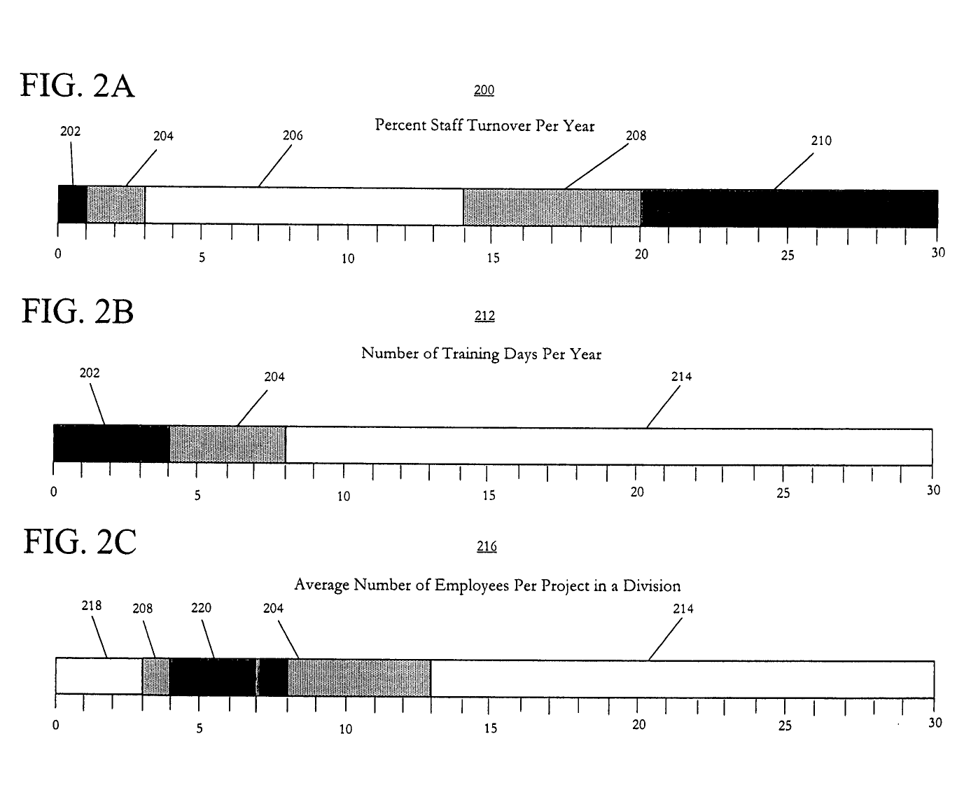

Indicator representations associated with these indicators are determined in step 100. Each indicator representation is associated with one of the indicators and based on the indicator values of the one associated indicator. FIGS. 2A-C illustrate three exemplary graphical indicator representations of indicators that are referred to as key risk indicators (KRI's). Specifically, staff turnover representation 200 is an exemplary graphical representation of the relative desirability of a staff turnover KRI, the percent of staff turnover per year; staff training representation 212 is an exemplary graphical representation of the relative desirability of a staff training KRI, the average number of training days per year per staff member; and project staffing KRI 216 is an exemplary graphical representation of the relative desirability of a project staffing KRI, the average number of employees per project in a division of an organization. It is noted that other types of indicator representations, such as tabular or textual, may also be used in exemplary embodiments of the present invention.

Each of the exemplary indicator representations of FIGS. 2A-C includes: at least one first range of indicator values; at least one second range of indicator values; and at least one third range of indicator values. The first range generally indicates a desirable situation for the indicator and the third range generally indicates an undesirable situation for the indicator, with the second range indicating an intermediate situation. Thus, each first range of an indicator representation is contiguous with at least one second range of the indicator representation, each second range of the indicator representation is contiguous with one first range and one third range of the indicator representation, and each third range of the indicator representation is contiguous with at least one second range of the indicator representation. Another way of saying this is that there is always an intermediate range between a desirable range and an undesirable range of the indicator representations.

In many circumstances, these ranges may be thought of as the first (or desirable) range representing a normal situation and requiring no escalation; the second (or intermediate) range representing a situation that may require some heightened state of alertness, some escalation, and/or reporting to management; and the third (or undesirable) range as representing a situation that requires action, more complete escalation, and/or reporting to management. Such a pattern of ranges of criticality is common in both management and control environments. Increasing criticality indicates circumstances in which management is desirably escalated; decreasing criticality indicates circumstances in which the management may reasonable left at the current level or reduced, i.e., the associated tasks may be delegated. It is contemplated that exemplary indicator representations may include additional ranges, e.g. a highly desirable range and/or a highly undesirable range, to provide finer granularity.

For exemplary graphical representations of KRI's (or other indicators), a desirable range may also be known as a green risk level range, an intermediate range may also be known as a yellow risk level range, a third range may also be known as a red risk level range. Green risk level ranges are associated with situations in which the risk represented by the KRI requires only a low level of attention, action, or reaction; yellow risk level ranges, with those situations needing an intermediate level of attention, action, or reaction; and red risk level ranges, with situation in which a high level of attention or action is desired. FIGS. 2A-2C could be made in color, with the shaded areas colored accordingly.

For example, FIG. 2A, illustrates an exemplary indicator representation of a indicator with one desirable range of indicator values between two third ranges, i.e. a indicator for which there is an intermediate range of desired values. Thus, this exemplary representation 200 of the staff turnover KRI, includes: one desirable range of indicator values, middle green risk level range 206 (3% turnover/year to 14% turnover/year); two intermediate ranges of indicator values, lower yellow risk level range 204 (1% turnover/year to 3% turnover/year) and upper yellow risk level range 208 (14% turnover/year to 20% turnover/year); and two third ranges of indicator values, lower red risk level range 202 (0% turnover/year to 1% turnover/year) and upper red risk level range 210 (more than 20% turnover/year).

FIG. 2B, illustrates an exemplary indicator representation of an indicator for which the desired range of values is open-ended and, thus, includes upper green risk level range 214. FIG. 2C, illustrates an exemplary indicator representation of a indicator with one third range of indicator values between two desirable ranges, i.e. a indicator for which there is an intermediate range of undesirable values. Therefore, instead of having: middle green risk level range 206; lower red risk level range 202; and upper red risk level range 210, exemplary representation 216 of the project staffing KRI includes: lower green risk level range 218; upper green risk level range 214; and middle red risk level range 220. Note that with reference to yellow risk level ranges the terms upper and lower are used only to refer to the side of the contiguous green risk level range that the yellow risk level range is on; and with reference to green and red risk level ranges the terms middle, upper, and lower are used only to refer to the portion of the scale of indicator values that the risk level range is in.

Once the indicator representations are determined, indicator input means may be used to input to an exemplary system to perform the exemplary method. These indicator input means may include a keyboard, keypad, mouse, track ball, joystick, or other means used to input information into a computer or similar system, including downloading information from a database or other information source. Alternatively, the indicator information may be loaded into the exemplary system using a computer-readable medium. Such computer-readable media include; integrated circuits, magnetic and optical storage media, as well as audio-frequency, radio frequency, and optical carrier waves.

Referring again to FIG. 1, a current value for each of the indicators is also provided in step 102. These current indicator values may also be desirably input into the exemplary system used to perform the exemplary method using current value input means which may be similar to, or the same as, the indicator input means.

Because of the volume of indicators for which information may be desired, an organization, particularly a large organization with multiple divisions, may produce a vast array of indicator representations. In such a situation, a way to condense the information, without significant loss is desirable. As may be seen in the exemplary indicator representations of FIGS. 2A-2C, even in the restricted set of graphical indicator representations for indicators that are KRI's, there is significant variety, with different qualitative forms and widely divergent scales, not to mention often incommensurate and/or unrelated indicators. Thus, it may be difficult, if not impossible, to meaningfully combine these indicator representations directly to provide condensed information to management.

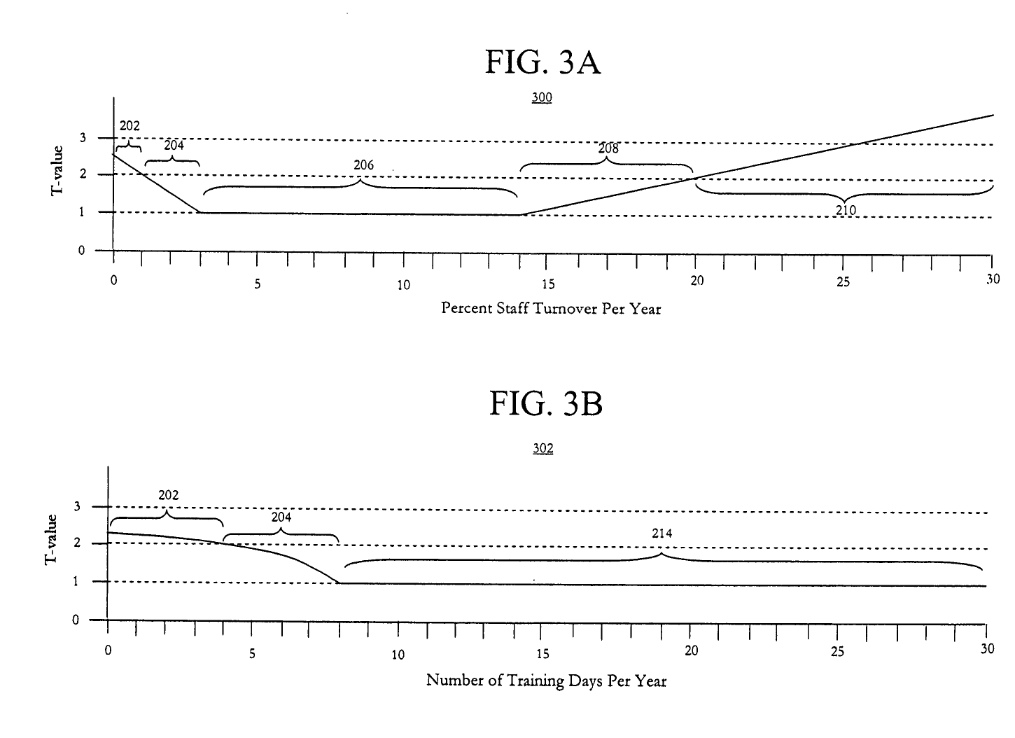

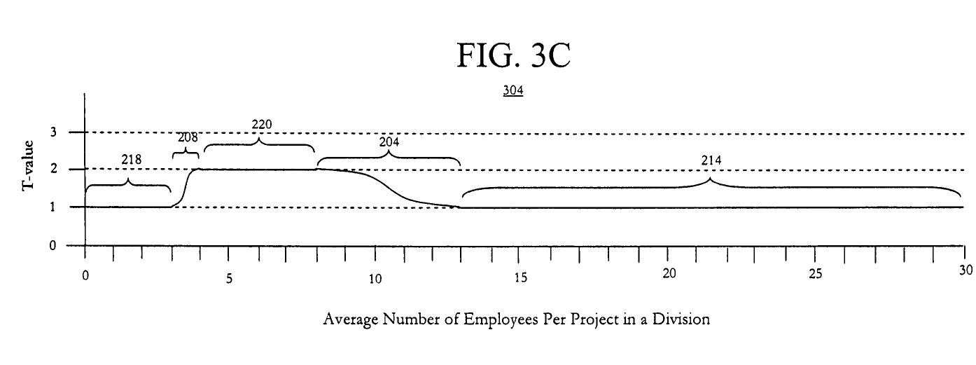

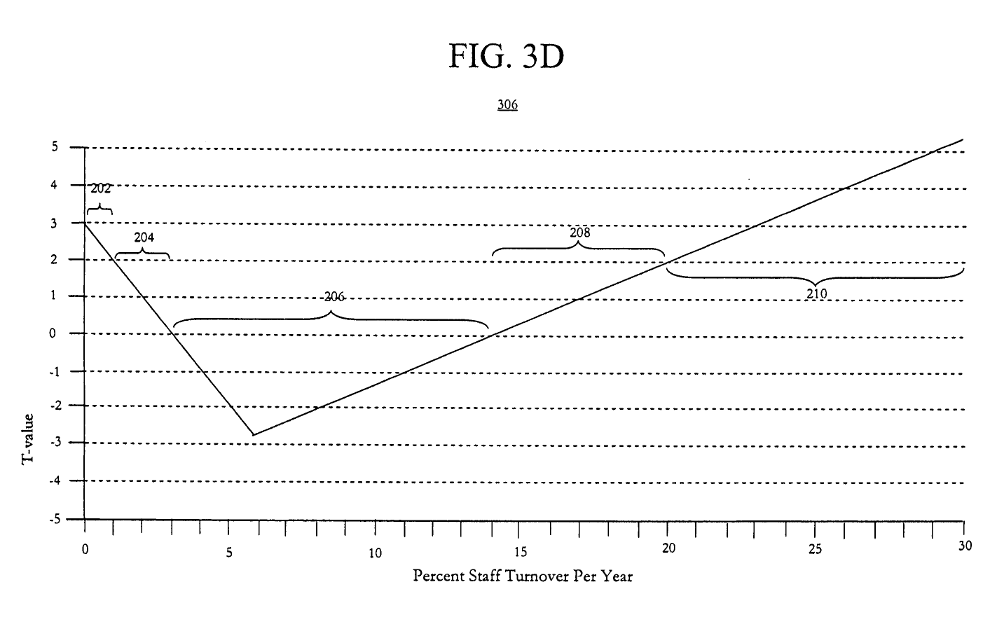

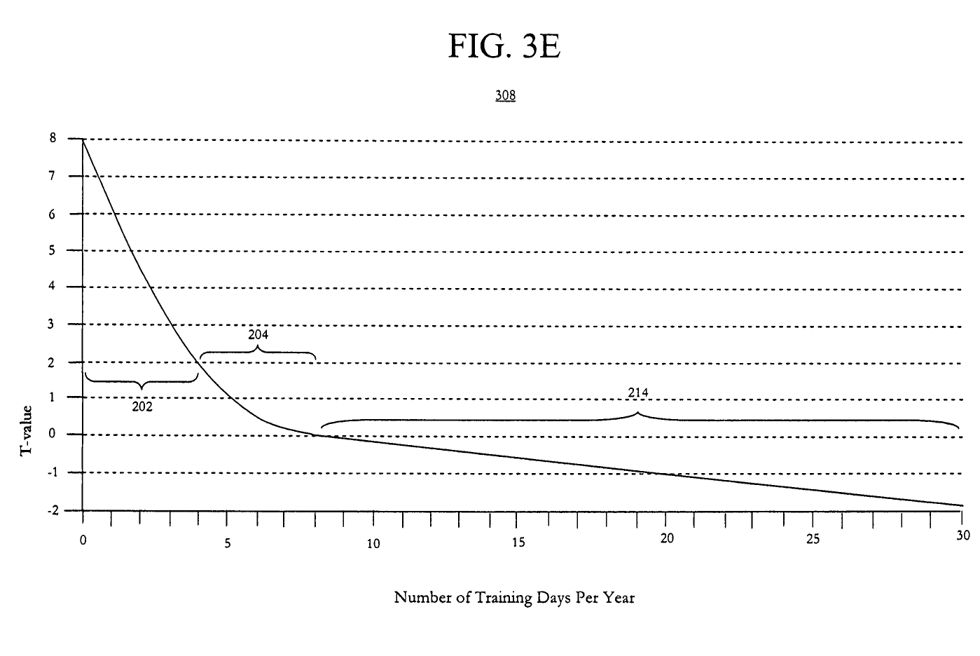

Therefore, it is desirable to transform the disparate indicator representations into a common form from which a composite indicator may be formed. In the exemplary method of FIG. 1, each indicator representation is a T-value function associated with indicator representation is established in step 104. Each T-value function maps indicator values to T-values based on the ranges of indicator values from the associated indicator representation. The resulting transformation may be applied to a wide subclass of indices used in an organization, or in a machine or control device to monitor some aspect of performance through periodic or continual observations and/or calculation. This transformation may be performed using a T-value processor that is coupled to the indicator input means. FIGS. 3A-E illustrate several exemplary T-value functions that may be used with exemplary embodiments of the present invention.

FIG. 3A illustrates exemplary T-value function 300, which corresponds to exemplary representation 200 of the staff turnover KRI of FIG. 2A. In exemplary T-value function 300, a constant T-value equal to 1 is assigned to indicator values in middle green risk level range 206. The indicator values at the boundaries between yellow risk level ranges and red risk level ranges are assigned a T-value of 2. The T-values associated with indicator values outside middle green risk level range 206 vary with indicator value such that the T-values vary linear across each yellow risk level range from 1 at the boundary of the yellow risk level range with the contiguous green risk level range to 2 at the boundary of the yellow risk level range with the contiguous red risk level range. Thus, T-value function 300 has a slope of −½ in lower red risk level range 202 and lower yellow risk level range 204; zero in middle green risk level range 206; and a slope of ⅙ in upper yellow risk level range 208 and upper red risk level range 210.

It is noted that the T-values assigned to indicator values at the boundaries between ranges are also known as threshold values, because the T-value represent thresholds between the ranges of indicator values.

FIG. 3B illustrates exemplary T-value function 302, which corresponds to exemplary representation 212 of the staff training KRI of FIG. 2B. In exemplary T-value function 302, a constant T-value equal to 1 is assigned to indicator values in upper green risk level range 214 and the indicator value at 4 (the boundary between lower yellow risk level range 204 and lower red risk level range 202) is assigned a T-value of 2. The T-values associated with lower yellow risk level range 204 and lower red risk level range 202 vary with indicator value such that it matches the assigned T-values at the ends of lower yellow risk level range 204 and the slope of the T-values increases with indicator value across lower red risk level range 202 and lower yellow risk level range 204.

FIG. 3C illustrates exemplary T-value function 304, which corresponds to exemplary representation 216 of the project staffing KRI of FIG. 2C. In exemplary T-value function 304, a constant T-value equal to 1 is assigned to indicator values in both green risk level ranges 214 and 218, and a constant T-value equal to 2 is assigned to indicator values in middle red risk level range 220. The T-values associated with yellow risk level ranges 204 and 208 vary smoothly and monotonically between 1 and 2 from the contiguous green risk level range to middle red risk level range 220.

FIG. 3D illustrates exemplary T-value function 306, which corresponds to exemplary representation 200 of the staff turnover KRI of FIG. 2A. Exemplary T-value function 306 is similar to exemplary T-value function 300, except that scale is changed and the linear sections of exemplary T-value function 300 have been extended into middle green risk level range 206 until their intersection. Thus, the T-value for indicator values in middle green risk level range 206 is not constant in this example.

FIG. 3E illustrates exemplary T-value function 308, which corresponds to exemplary representation 212 of the staff training KRI of FIG. 2B. In exemplary T-value function 308, a T-value equal to 0 is assigned to a indicator value of 8 (the boundary between lower yellow risk level range 204 and upper green risk level range 214) and the indicator value of 4 (the boundary between lower yellow risk level range 204 and lower red risk level range 202) is assigned a T-value of 2. The T-values associated with lower yellow risk level range 204 and lower red risk level range 202 vary with indicator value such that it matches the assigned T-values at the ends of lower yellow risk level range 204 and the slope of the T-values decreases with indicator value across lower red risk level range 202 and lower yellow risk level range 204. T-value function 308 varies linearly in upper green risk level range 214 with a slope of − 1/12.

Although, in the exemplary T-value functions FIGS. 3A-3E, higher T-values represent less desirable circumstances of the indicators, one skilled in the art will understand that this represents an arbitrary user selection and T-value functions in which higher T-values represent more desirable circumstances of the indicators may be used in exemplary embodiments of the present invention, as well.

As may be noted from these examples, T-value functions according to exemplary embodiments of the present invention may take many forms. T-value functions, however, all possess certain characteristics:
1) every T-value function is a continuous function;
2) every T-value function has a first predetermined threshold T-value for every indicator value that is on a boundary between a desirable range of indicator values and an intermediate range of indicator values;
3) every T-value function has a second predetermined threshold T-value for every indicator value that is on a boundary between an intermediate range of indicator values and a undesirable range of indicator values;
4) every T-value function is monotonic (i.e. continually increasing or decreasing) in every intermediate range of indicator values;
5) every T-value function has the same functional form, except for scaling and mirroring, across each intermediate range of indicator values; and
6) no T-value function has a T-value for any indicator value in either a desirable range of indicator values or an undesirable range of indicator values that is between the first and second predetermined threshold T-values.

In the exemplary embodiment of FIG. 1, an additional restriction is placed on the T-value function, namely that the T-value in the desirable range of indicator values is constant and equal to the first threshold T-value. This restriction may be particularly desirable in situations where the user does not want to allow a high degree desirability in one indicator to mask a potential problem in another indicator.

The functional form of the T-value function within the intermediate and undesirable ranges of indicator values, as well as the scaling (defined by the first and second threshold T-values), is based on knowledge of the organization, or organizational unit, for which the composite indicator is being formed, as well as the manner in which the T-values are to be used in determining the composite indicator value. For example, if current T-values are multiplied to determine the composite indicator value, then it may be desirable to set the first threshold value equal to 1 (as shown in FIGS. 3A-3C); however, it would be very undesirable to set the first threshold value equal to 0. Alternatively, if current T-values are averaged to determine the composite indicator value, then it may be desirable to set the first threshold value equal to 0.

By way of example, a relatively simple T-value function similar to T-value function 300 may be formed as follows. Two kinds of threshold are defined, Y(0) thresholds, on the border between desirable and intermediate ranges of indicator values, and Y(1) thresholds on the border between intermediate and undesirable ranges of indicator values. Threshold points may desirably be defined to belong to one of the two ranges they separate. For example, the threshold may be defined as $10 m, where the undesirable range is $10 m and above and the intermediate range is below $10 m and above $5 m. $10 m is then in the undesirable range.

The T-value transformation may be defined as a transformation T of any such indicator representation I, that takes indicator values x over some compact set of the Real Line or its equivalent as follows:

When x is in any desirable range or is at the boundary between any desirable range and any intermediate range, T(x)=1.

At the boundary between any intermediate range and any undesirable range, T(x)=2.

In any intermediate range where the range is bounded by a threshold Y(0) with an intermediate range and Y(1) with a undesirable range, T(x)=(x−Y(0))/(Y(1)−Y(0))+1.

In any undesirable range that has only one intermediate neighbor, so that it is at the boundary of the subset of values of the underlying indicator, T(x)=(x−Y(0))/(Y(1)−Y(0))+1, where the Y(0) and Y(1) are defined by the neighboring intermediate range.

In any undesirable range, that has two intermediate neighbors, the first bounded by thresholds Y₁(0) and Y₁(1) and the second by thresholds Y₂(0) and Y₂(1), T(x)=Min((x−Y₁(0))/(Y₁(1)−Y₁(0))+1, (x−Y₂(0))/(Y₂(1)−Y₂(0))+1).

This exemplary T-value transformation is thus a continuous transformation that is piecewise linear. T(x) and x are in the undesirable range for the same values of x, in the intermediate range for the same values of x and in the desirable range for the same values of x. In other words, the exemplary T-value transformation preserves the thresholds and ranges of x into T(x).

The result of the exemplary T-value transformation is an exemplary T-value function of the underlying indicator representation, I.

The exemplary T-value of an indicator may be defined as follows. It takes: values of 1 or less when the indicator value is in a desirable range; a value of 1 at the threshold between any desirable and intermediate range; a value between 1 and 2 inside the intermediate range, increasing monotonically and continuously as the indicator value moves from the threshold with the desirable range toward a undesirable range; the value 2 at any threshold between a intermediate range and a undesirable range; and a value of 2 or more in a undesirable range, increasing monotonically as it moves away from a intermediate level-undesirable threshold, until it approaches any other intermediate level-undesirable threshold that may be there when begins to decline.

Transformations other than this exemplary T-value transformation may produce other exemplary T-value functions. For example, a hyperbolic function may be used to form an exemplary T-value function associated with an indicator representation with just five ranges, i.e. undesirable level-intermediate level-desirable level-intermediate level-undesirable level. Moreover, this exemplary T-value function may be parameterized such that it varies below 1 in the desirable range and equals 1 only at the thresholds with intermediate ranges, which may be a desirable feature for some situations.

Modified trigonometric functions or functions from other analytic families, such as monotonic polynomial functions; exponential functions; logarithmic functions; or arctangent functions, may be used to produce T-value transformations of indicator representations that have more complex patterns of ranges. Exemplary T-value functions formed in this manner may be continuously differentiable, such as, for example, exemplary T-value function 304 of FIG. 3C.

T-value functions may be desirably formed such that changes around threshold values have the same significance from a management or control viewpoint, regardless of the range over which the original indicator value varied. Also, T-values always change monotonically, rising toward greater criticality, going from normal to alert to action. This may not be the case, however, for some underlying indicator representations that vary through one or more undesirable level, intermediate level, and desirable ranges and back again as they increase. Other indicator representations that are monotonic may decline as criticality increases. Moreover, in any group of indicator representations there may be significant differences in sensitivity, so that a 1% change in one indicator representation is the equivalent of much larger change in another indicator representation, in terms of the difference it makes from a management or a control viewpoint. This diversity makes the comparison or aggregation of changes in untransformed indicator representations very difficult.

Returning to the exemplary method of FIG. 1, a current T-value corresponding to each indicator is calculated using the current value of the indicator and the associated T-value function, step 106. This calculation may be performed by a calculation processor coupled to the current value input means and the T-value processor.

The current T-values are then combined to calculate the composite indicator value, step 108. This step may be performed using a compositing processor coupled to the calculation processor.

A number of approaches may be used to combine the current T-value, depending on the relationship(s) of the underlying indicators and the information being sought from the composite indicator. Exemplary approaches to combining the current T-values to calculate the composite indicator value include: calculating a weighted or unweighted sum of the current T-values to be the composite indicator value; calculating weighted or unweighted a product of the current T-values to be the composite indicator value; and selecting the maximum, weighted or unweighted, current T-value to be the composite indicator value. The use of weightings allows exemplary methods of the present invention to be customized to account for the perceived relative importance of the underlying indicators. It is noted that, by properly selecting the weights assigned to different T-values, the resulting composite indicator value may be the (weighted or unweighted) arithmetic mean, i.e. average, or the geometric mean of the current T-values. It is also noted that if the T-value transformation is defined such that a high T-value represents a desirable indicator value, rather than a low T-value representing a desirable indicator value, then it may be desirable to select the minimum, weighted or unweighted, current T-value to be the composite indicator value. It is further noted that a multiplicative or exponential weighting of 1 is contemplated within exemplary embodiments of the present invention, although the resulting weighed value is the same as the original unweighted value.

Additionally, a combination of these exemplary approaches may be used. For example, in many situations it may be desirable to separate the underlying indicators into sets of indicators, such that all indicators of each set are related to each other, but the indicators of one set are unrelated to the indicators in other sets. In these situations, a sum or product of the current T-values associated with the indicators of each set of indicators may be calculated to determine a set indicator value for each set. The sum or product may be weighted or unweighted. These operations allow all of the indicators of each to contribute to the resulting set indicator value. Because the underlying indicators are related and may operate synergistically, this approach is typically desirable.

Because the indicators in different sets are unrelated, however, there is much less likelihood of such synergy. Therefore, the set indicator values may be weighted, although equal weighting is possible, and the maximum weighted set indicator value selected to be the composite indicator value.

Two forms of exemplary indicator representations that may be used with exemplary methods of the present inventions are key risk indicator (KRI) representations, which indicate the operational risk level associated with one of the indicators, and key performance indicator (KPI) representations, which indicate the performance level associated with one of the indicators.

If KRI's are used: the composite indicator value may be called a composite risk indicator value; and the desirable, intermediate, and undesirable ranges may be called green, yellow, and red risk level ranges, respectively. The composite risk indicator value may be compared to a predetermined risk value and reported to management if it is greater than or equal to the predetermined risk value.

Exemplary KRI's may include a number of different indicators, such as: best practice/compliance issues raised by external professional bodies; open complaints from consumer groups, activists, and ombudsman; open complaints from regulators; corporate conflicts of interest detected that were not identified in advance; the total value of customer and client compensation cases settled; the total value of ex-gratia payments; external audit points overdue; external authority, regulatory, and/or industry alerts received; the total value of fee and charge waivers; help desk calls from customers; overdue internal audit points; breaches of internal information barriers; overdue investigation items internally; pending litigation cases; changes in senior management; market practice changes in pipeline; operational loss events; organizational change; personal conflicts of interest detected that were not identified in advance; open physical and information security review and audit issues; detected policy and control exceptions or failures; profit and loss write-offs; regulatory enforcements within the industry; regulatory investigations; average number of sick or non-holiday absence days per employee; staff employment tenure; staff turnover percentage; tip-offs received; substantiated instances of whistle-blowing; staff training indicators; inventory indicators; accounts receivable indicators; accounts payable indicators; and staff productivity indicators.

If KPI's are used the composite indicator value may be called a composite performance indicator value. The composite performance indicator value may be to a predetermined performance value so that remedial action may be taken if the composite performance indicator value is greater than or equal to the predetermined performance value. Composite performance indicator values may also be used to assist in compensation determinations.

Exemplary KPI's may include a number of different indicators, such as: average collection period; average time for response to a customer inquiry; chargeable ratio; current ratio; customer loyalty index; customer satisfaction index; customer satisfaction survey score; gross profit margin; input use per unit of output; machine planned maintenance downtime; machine unplanned maintenance downtime; net labor cost multiplier; number of items processed per employee; number of rejects per 1000 items processed; profit before taxes; return on capital; revenue growth; same store sales growth; yield per hectare; and z score liquidity measure. As may be noted from this exemplary list, KPI's may vary wildly between industries and/or job description.

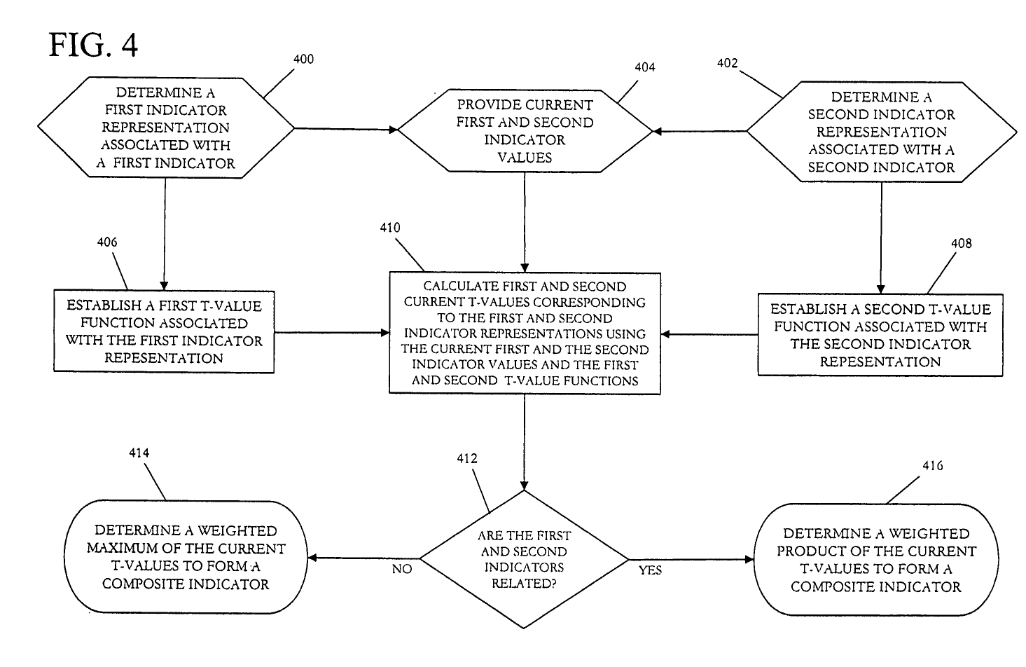

FIG. 4 illustrates another exemplary method for determining a composite indicator value. In the exemplary method of FIG. 4, the composite indicator value is described as associated with two indicator representations that each has a plurality of indicator values. This exemplary method is similar to the exemplary method of FIG. 1. One skilled in the art will understand that the inclusion of only two underlying indicators in the exemplary embodiment of FIG. 4 is for illustrative purposes and is not intended to be limiting.

A first indicator representation associated with the first indicator is determined in step 400, and a second indicator representation associated with the second indicator is determined in step 402. Each of these indicator representations includes: at least one desirable range of indicator values; at least one intermediate range of indicator values; and at least one undesirable range of indicator values. As in the exemplary method of FIG. 1, each desirable range is contiguous with at least one intermediate range; each intermediate range is contiguous with one desirable range and one undesirable range; and each undesirable range is contiguous with at least one intermediate range.

A current indicator value is provided for both the first and the second indicator as shown in step 404.

A first T-value function associated with the first indicator representation is established in step 406, and a second T-value function associated with the second indicator representation is established in step 408. As in the exemplary embodiment of FIG. 1, each of these T-value functions is a continuous function. The indicator values in each desirable range of these T-value functions may have T-values that are not constant, but may vary, as illustrated in exemplary T-value functions 306 and 308 in FIGS. 3D and 3E, respectively. If the T-value function for indicator values in the desirable range(s) is not constant, it is a continuous function with a single minimum in each desirable range of indicator values. Thus, these variable desirable T-values are equal to a maximum first range value at each boundary with an intermediate range and are less than the maximum first range value for other desirable range indicator values. For example, in FIG. 3D, middle desirable range 206 has a single minimum at an indicator value of 5.75%. In FIG. 3E, although T-value function 308 is monotonically decreasing in upper desirable range 214, it also has a single minimum value at the maximum indicator value of this range, i.e. 365 days. Although both exemplary T-value functions 306 and 308 use (piecewise) linear variations for their desirable range portions, it is contemplated that other functional forms with single local minima, such as parabolic, hyperbolic, and sine curves, may be used.

A first current T-value corresponding to the first indicator is calculated using the first T-value function and the current first indicator value; and a second current T-value corresponding to the second indicator is calculated using the second T-value function and the current second indicator value, step 410.

It is determined whether the first and second indicators are related in step 412. If the first indicator and the second indicator are determined to be unrelated, then the composite indicator value is determined to be the maximum of the first current T-value and the second current T-value in step 414. If the first indicator and the second indicator are determined to be related, then the composite indicator value is determined to be the product of the first current T-value and the second current T-value in step 416. In both step 414 and step 416, one or both of the first current T-value and the second current T-value may be weighted to represent relative perceived importance of the underlying indicators before the composite indicator value is determined.

Allowing the T-value function to include variable values in the desirable range may allow a high degree of desirability of a particular indicator to somewhat counterbalance intermediate or undesirable results of other indicators. Such counterbalancing, however, is only effective for T-values associated with related indicators in this exemplary method because composite indicator values for unrelated indicators are calculated by selecting the maximum (weighted) T-value. Thus, problems in one area are not masked by totally unrelated successes in this exemplary method.

As in the exemplary method of FIG. 1, two exemplary types of composite indicator values are composite risk indicator values and composite performance indicator values.

Following the previous example described above with reference to FIG. 1, the usefulness of the selection of criticality ranges in layered organizations or processes may be demonstrated. For example, the different ranges (desirable, intermediate, and undesirable) may be used to indicate when it is desirable for the underlying situations to be referred from one level to the level above it within an organization, or process. Thus, an indicator value in the desirable range of the associated indicator representation is not generally referred upward; an indicator value in the intermediate range may be referred upward, but with a relatively low priority, such as in a watching brief or on a reporting basis; and an indicator value in an undesirable range may be referred up with a higher priority or a call for action. A situation, then, that is listed in an undesirable range in an indicator representation for one level within an organization, or process, may be only be in an intermediate range, or even a desirable range, in the indicator representations of a higher level. This multi-level sensitivity may be created by selecting different thresholds to divide the ranges in the underlying indicators, or by re-weighting the current T-values. In effect, the thresholds dividing ranges of the indicator representations, as well as the formulae used to combine the T-values, embody rules or policies for escalation and, looking at it the other way, for delegation of responsibility.

One potential issue in managing large organizations, or complex processes, is that it may be desirable, at the lower levels, to use large numbers of disparate indicator representations, subsets of which may be viewed by a number of different managers. The amount of information to be processed by more senior levels of management, however, may become overwhelming without some form of filtering. Therefore, it is desirable that situations are selectively escalated. However, this means that the information associated with these situations is filtered.

The repeated application of criticality ranges to filter what information rises through an organization is a Level Schema. When those ranges are applied at each level to composite indicators, the compaction of information for senior management (or process control) becomes doubly efficient.

The standard set of formulae used to combine T-values may be applied to T-values developed at any level of an organization to combine these lower level T-values into composite indicators for the next level upward, e.g. divisional T-values may be combined for reporting to the corporate level. In an exemplary embodiment, these composite indicators may be calculated two ways: using formulae F1 and F2 which create T-values at the next level up in the organization (or control hierarchy); or using simpler formulae G1 and G2, which are then converted to higher level T-values using an exemplary T-value transformation. As illustrated in the following two sections, these two approaches are very nearly equivalent.

### Approach 1

The first approach, a generalization of the exemplary method of FIG. 4, uses two formulae. The first formula (F1) is applied to groups of indices, which are similar but unrelated. For these, the next level of management is generally interested in knowing whether any one indicator representation is especially critical, i.e. far into the undesirable range. Formula F1, therefore, incorporates a weighted maximum of T-values associated with the underlying indicator representations. The second formula (F2) is applied to groups of indices that are different, but related. In these situations, management wants to understand whether the indicator representations suggest a pattern of contributory forces that, collectively, reinforce one another sufficiently to suggest a situation that is sufficiently critical to warrant their attention. Formula F2, therefore, incorporates a product of weighted T-values associated with the underlying indicator representations.

So, for example, F1 may be used to calculate a staff turnover composite indicator of staff working in three different locations, in three different labor markets, based on staff turnover T-values from each market: F2 may be used to combine staff turnover and staff training T-values into a staff quality composite indicator for a single location.

If T(i), i={1, n}, are T-values for n unrelated indices, then a composite indicator C may be derived for these T-values using F1:

C=Max(1,α*(T(i)^{v(i)}))^{β}_{i={1, n}}) F1

where v(i)> or equal to 0, β>0 and 0<α<1.

If T(j), j={1, m}, are T-values for m related indices, then a composite indicator D may be derived for these T-values using F2:

D=Max(1,δ*Π(T(j)^{w(j)})^{γ}_{j={1, m}}) F2

where Σ_{j={1, n}}w(j)=1, w(j)> or equal to 0 and γ>0, 0<δ<1.

The weighting factors v(i) and w(j) desirably reflect the relative sensitivity of the composite indicators C and D to the different underlying T-values and β and γ reflect the relative sensitivity of the whole composite to the underlying indicators as a group. The larger their values, the faster the composite rises through the intermediate range and the further it rises into the undesirable range. Sensitivity parameters α and δ are directly related to how broad the desirable range of the composite is. The lower their values, the further the green range extends. So, generally, the lower the value of these parameters, the fewer associated situations are escalated and, correspondingly, the more they are delegated.

Composite indicators C and D equal 1 if, and only if, the underlying T-values are equal to one or the parameters α or δ are small enough and the terms α*(T(i)^{v(i)}))^{β} and δ*Π(T(j)^{w(j)})^{γ}_{j={1, m}} are not so large that the terms on the right hand sides of F1 and F2 are less than one. Thus, if composite indicators C and D may be thought of as T-values themselves, they are always in the desirable range when the underlying T-values are in the desirable range, which may be a desirable quality. Their parameters may be chosen so as to make them enter an intermediate range at the point at which the underlying situations described by the indicators (and T-values) that make them up warrant escalation from desirable to intermediate level. Composite indicators C and D may be scale such that they approach and surpass a second predetermined threshold as the underlying T-values increase into an undesirable range. They do so from a point that depends on the values of α and δ and at a rate that depends on the individual T-value weights and the size of the overall scaling parameters, β or γ.

### Approach 2

In the second approach, the formulae for C and D are simpler, but they are not generally T-values themselves at the level above that of the underlying indicator representations. Still, to convert them to T-values, one need only apply an exemplary T-value transformation described above, choosing the parameters Y(0) and Y(1) appropriately to escalate upward (or delegate downward) issues appropriately.

If T(i), i={1, n}, are T-values for n unrelated indices, then a composite indicator C may be derived for these T-values using G1:

C=Max(T(i)^{v(j)}))_{i={1, n}} G1

where Σ_{i={1, n}}v(i)=1, v(i)> or equal to 0.

If T(j), j={1, m}, are T-values for m related indices, then a composite indicator D may be derived for these T-values using G2:

D=Π(T(j)^{w(j)})_{j={1, m}} G2

where Σ_{j={1,}}w(j)=1, w(j)> or equal to 0.

As in Approach 1, weighting factors v(i) and w(j) reflect the relative sensitivity of the composite indicators C and D to the different underlying T-values and β and γ reflect the relative sensitivity of the whole composite to the underlying indicators as a group.

An exemplary threshold estimation methodology may be used to create standard T-value functions based on statistical data of the underlying indicators or indices. The resulting T-values may be used as standard indices for market making, benchmarking and other purposes.

Thresholds between desirable, intermediate, and undesirable ranges may be established in organizations, or in processes, level by level, with a view to what is to be delegated or escalated down or up. The establishment of these thresholds is likely to differ between organizations, or even between different managers and/or levels of management within an organization. Therefore, if the exemplary embodiments of the present invention are to be used in a standard way across institutions, an exemplary approach that can be applied uniformly may be desired.

The following exemplary threshold estimation methodology is an exemplary approach for applying exemplary embodiments of the present invention in a standardized manner across institutions. It is based on the collection of indicator values of composite indicators from as large a sample of institutions as practical; or, in the instance of processes, the development from that sample of a frequency distribution, and the estimation of standard statistics of variation from the mean, mode, or median for that sample. Examples of standard statistics of variation may include standard deviation and quartiles. One skilled in the art will understand that other standard statistics of variation may be used as well. The suitability of these statistics of variation may depend on the shape of the distribution, particularly its symmetry, for example.

Using the example of standard deviations on a symmetrical distribution, the approach calls for setting the thresholds Y₁(0) and Y₂(0) (i.e. the desirable-intermediate range boundary) at a predetermined number of standard deviations from the mean and the thresholds Y₁(1) and Y₂(1) (i.e. the intermediate-undesirable range boundary) at a larger predetermined number of standard deviations from the mean. The T-value functions may then be defined without reference to the tendencies of any organization to delegate or escalate and T-value functions based on this exemplary threshold estimation methodology may be use to calculate standardized T-values for single firms or for samples of firms (or for single processes or groups of processes.)

As an example, the value of a standardized staff quality indicator for financial institutions may be that it may be used by an individual institution as a benchmark against which to judge whether its own staff quality was better or worse than the industry average. This may be accomplished by comparing the exemplary standardized T-value of the individual institution against the exemplary standardized T-value of the industry.

Alternatively, exemplary standardized T-value functions may be used as a basis to trigger insurance or risk transfer mechanism payouts or pricing. For example, a trigger may be set if the exemplary standardized T-value staff quality indicator of the individual institution exceeds some predetermined numerical threshold.

Within many organizations there exists a Level Schema that leads to a desire for different reporting of composite indicators to different levels within the organization. Another exemplary embodiment of the present invention includes an interview process whereby escalation and delegation thresholds, together with appetite parameters a and b (or α and β) can be established in organizations by level in different areas.

Consider two levels of management in a particular area. In this simplified Level Schema, there is a leader at level n in the area, and several individuals at level n+1 reporting to that leader. These two levels together constitute a reporting relationship.

Complex organizations may be made up of many such reporting relationships, nested within one another. Individuals that report to a leader in one reporting relationship may be the leader to whom others report in another. These reporting relationships may be quite stable or may change over time. People in the organization may occupy different positions within different aspects of the organization, so that their overall role is matrixed and involves many reporting relationships. Alternatively, in a more traditional organization, the role of manager may be fully characterized by a single reporting relationship up and a single reporting relationship down. The point is that this Level Schema and the related reporting relationship concept are very general and flexible.

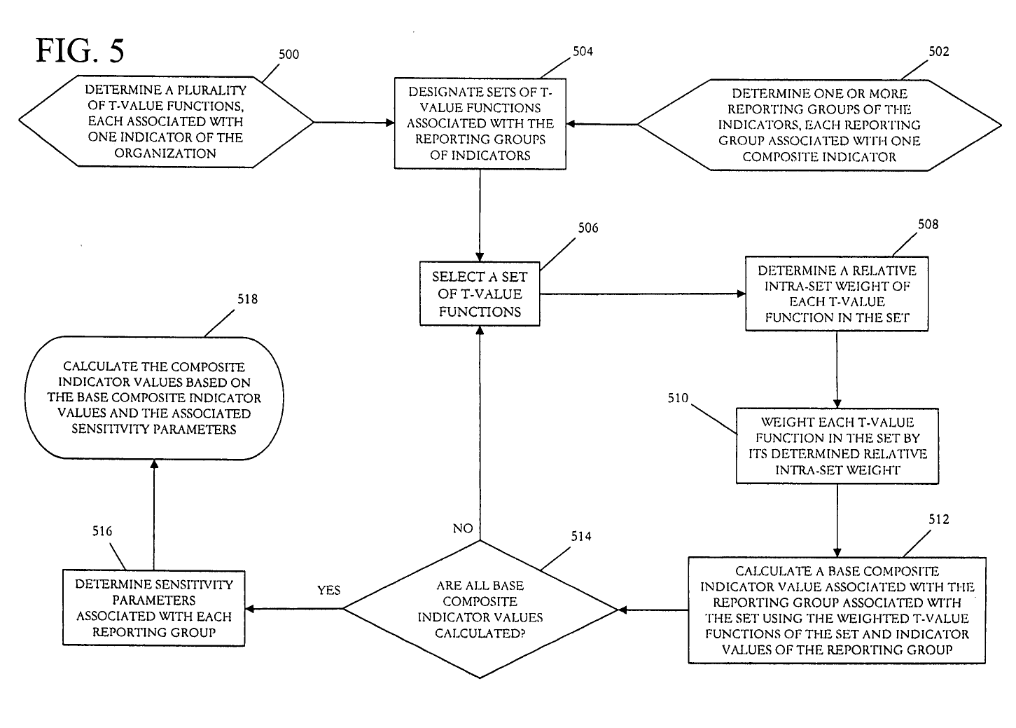

FIG. 5 illustrates an exemplary method of forming one or more composite indicators for reporting on a plurality of indicators of an organization according to the present invention. This exemplary method may incorporate an exemplary interview process. The exemplary interview process may be used, in the first instance, to establish thresholds and parameters, such as sensitivity parameters and weighting factors, within a reporting relationship in which a number of level n+1 managers reporting to one level n manager regarding a number of different indicators.

Consider an exemplary situation in which a level n+1 manager has already developed a set of T-value functions. That manager and their level n supervisor meet one-on-one (or collectively with all the level n+1 managers in the reporting relationship) to discuss different ways in which these T-value functions may be used for reporting information about the underlying indicators to the level n manager in a condensed form. During this discussion, the T-value functions may desirably be reviewed to determine three reporting issues:
1) the groupings of the T-value functions desired by the level n manager to form different composites indicators (or indices);
2) the desired weighting of T-value functions within each grouping; and
3) the desired setting of sensitivity parameter values (risk appetite) for each of the grouping.

Although it is desirable for specifics of these issues to be developed during this interview process, in many cases, the level n and level n+1 managers may be working with guidelines established centrally within the organization, where some thought should have been given to what information is required to be communicated up through several levels of management, the relative weights different indicators (and/or lower level T-values) should have and how much sensitivity to the underlying indicators (for example, how much risk appetite in the case of KRI's) senior management may expect to see at different levels of management.

In the exemplary method of FIG. 5, the process begins with designating the T-value functions to be used in step 500. Each T-value function is associated with one of the indicators that are established for reporting in the organization. These T-value functions may be formed using any of the exemplary procedures described above with reference to the exemplary methods of FIGS. 1 and 4.

One or more reporting groups of the indicators are determined in step 502. The T-value functions are separated into one or more sets such that each set of T-value functions includes the T-value functions associated with the indicators of one reporting group of indicators in step 504. Each of these reporting groups (and the associated set of T-value functions) is associated with a composite indicator, so that the composite indicator may be used to report composite information regarding the indicators within the reporting group. Selecting the indicators to be included in each reporting group allows a level n manager to tailor the reporting of the information being generated on the various indicators that they receive. Together with the level n+1 manager(s), the level n manager may establish how the level n manager would like to see the T-value functions grouped into different composite indicators. For example, some managers may group one set of indicators into an “Exceptions Index;” others may group another set of indicators into a “Staff Quality Index.” These choices then lead to the organization of the T-value functions into sets that are used to generate these composite indicators. It is noted that in exemplary embodiments of the present invention the reporting groups need not be exclusive, i.e. an indicator may be in more than one reporting group and, thus, the associated T-value function may contribute to more than one composite indicator.

As an example, consider a level n+1 manager who is monitoring six indicators, from which six key risk indicator (KRI) representations and six associated T-value functions are formed. These exemplary KRI's are: audit points; average days until reconciliation; processing errors; staff experience; staff turnover; and training days. The level n+1 manager goes through the grouping step, desirably with input from their level n manager. As a result, it is determined that these indicators should be grouped into three exemplary reporting groups from which composite indicators for reporting to the level n manager may be generated. The three exemplary reporting groups, and associated composite indicators, are: a Staff Quality Index, which includes the Training Days, Staff Turnover, and Staff Experience KRI's; a Processing Quality Index, which includes the Processing Errors and Average Days until Reconciliation KRI's; and an Overall Performance Index, which includes the Audit Points and Staff Experience KRI's. It is noted that, in this example, the indicator “Staff Experience” appears in two reporting groups, the Staff Quality Index and the Overall Performance Index.

Once the reporting groups are determined and the T-value functions are separated into corresponding sets, a set of T-value functions is selected from which to form a base composite indicator, step 506. A relative intra-set weight of each T-value function in the selected set of T-value functions is then determined, step 508. An exemplary interview procedure may be used to determine the relative intra-set weights of the T-value functions in the selected set. This exemplary interview process is described herein in terms of a level n and a level n+1 manager determining the desired relative intra-set weights of the T-value functions in the selected set through a series of questions. However, one skilled in the art will understand that a number of other methods may be used to determine the relative intra-set weights of the T-value functions in the selected set, such as using a priori knowledge of the relative importance of the underlying indicators to the organization or process being monitored and/or using historic data of the indicators.

In the exemplary interview process, for each composite indicator, the level n+1 manager, or the person tasked with developing the composite indicators, would ask the level n manager several questions about the various indicators that make up the reporting group; e.g., “How would you rank the indicators of this reporting group?” “Is there a subset of the indicators that you consider to be the key ones?” “Are there any indicators in this reporting group that you consider to be particularly similar to one another, i.e. highly related or equivalent?” As with the selection of the T-value thresholds and the reporting groups, this discussion of indicator priority may take into account centrally-developed guidelines as well as the opinions of the level n manager.

Tables 2 and 3 illustrate the development of the relative intra-set weight of each T-value function in the selected set of T-value functions using exemplary answers to this exemplary interview for demonstration purposes. This development uses an exemplary list of possible KRI's and T-value functions that might go into a Staff Quality Index. Table 1 illustrates an exemplary input table for documenting exemplary answers to the interview questions and Table 2 illustrates an exemplary table of calculations that may be used to determine the relative intra-set weights of the T-value functions in the selected set.

Table 1 is a method of recording the discussion between the managers at levels n and n+1 so that the rankings and grouping that result may be easily reviewed.

TABLE 1
Input Table

| | | Is there a subset of | Are there any |
|---|---|---|---|
| | How would you rank | these indicators that | indicators here that |
| | these indicators? (1 = most | you consider to be the | you consider to be very |
| | important) | key ones? | similar to one another? |
| Disciplinary Actions | 10 | | |
| Education Level | 5 | | |
| Performance at Last | 4 | x | |
| Review | | | |
| Position Difficulty | 6 | | |
| Ranking | | | |
| Staff Experience in | 7 | | a |
| Company | | | |
| Staff Experience in | 8 | | a |
| Function | | | |
| Staff Experience in | 3 | x | a |
| Industry | | | |
| Staff Experience in Unit | 9 | | a |
| Staff Turnover | 1 | x | |
| Training Days | 2 | x | |

Table 2 illustrates an exemplary series of separate calculations that may be performed based on interview results tabulated in Table 1. Column 1 of this table is a set of initial weights, assumed to be equal. Column 2 is the intra-set rankings of the indicators from Table 1, subtracted from 11 (the number of T-value functions in the set plus one), so as to give a value of 1 to the lowest and 10 to the highest ranked components. Column 3 assigns a key subset bonus factor of 10 to the “key” indicators identified in Table 1. This key subset bonus factor may be equal to the number of T-value functions in the set of T-value functions associated with the reporting group, or it may be a predetermined number selected to provide a desired additional weighting to the key indicators. Column 4 of Table 2 is the sum of Columns 1, 2, and 3. This sum provides an initial intra-set weight of each T-value function of the subset of related T-value functions that does not account for the effect of any subsets of related T-value functions. Column 5 assigns a value of one half of the minimum of the initial intra-set weights of the T-value function of each subset of related T-value function as the related subset correction factor of the subset. Column 6 is equal to Column 4 minus Column 5. Column 7 shows the values in Column 6 converted to percentage of the Column 6 total. Either the values in Column 6 or the percentages in Column 7 may be used as the relative intra-set weights of the T-value functions.

TABLE 2
Calculation Table

| | 1 | 2 | 3 | 4 | 5 | 6 | 7 |
|---|---|---|---|---|---|---|---|
| Disciplinary Actions | 5 | 1 | | 6 | | 6 | 4.6 |
| Education Level | 5 | 6 | | 11 | | 11 | 8.4 |
| Performance at Last Review | 5 | 7 | 10 | 22 | | 22 | 16.8 |
| Position Difficulty Ranking | 5 | 5 | | 10 | | 10 | 7.6 |
| Staff Experience in Company | 5 | 4 | | 9 | 3.5 | 5.5 | 4.2 |
| Staff Experience in Function | 5 | 3 | | 8 | 3.5 | 4.5 | 3.4 |
| Staff Experience in Industry | 5 | 8 | 10 | 23 | 3.5 | 19.5 | 14.9 |
| Staff Experience in Unit | 5 | 2 | | 7 | 3.5 | 3.5 | 2.7 |
| Staff Turnover | 5 | 10 | 10 | 25 | | 25 | 19.1 |
| Training Days | 5 | 9 | 10 | 24 | | 24 | 18.3 |
| | | | | | | 131 | 100.0 |

The rationale behind the subtraction of the related subset correction factors of Column 5 is that it may be desirable to reduce the likelihood that the inclusion of closely related T-value functions in the reporting group may give too much weight to some underlying cause (in this exemplary case, staff experience) just because it is covered by several (somewhat overlapping) indicators that are monitored. In this example, the T-value functions of the four overlapping Experience Indicator representations have a combined weight of 25.2% even after the related subset correction factor is subtracted, which is significantly more than any other single T-value function. If this relative intra-set weight of 25.2% for the T-value functions associated with the Experience Indicator representations seems too high to the level n and/or n+1 managers, then the related subset correction factors in Column 5 may be increased.

One skilled in the art will understand that this exemplary procedure to determine the relative intra-set weights of the T-value functions associated with a reporting group may be abbreviated, by, for example, removing the key subset bonus factor and/or the related subset correction factors from the calculation. Alternatively, other methods may be used.

It is noted that, once an initial set of relative intra-set weights has been determined from the interview, it may be desirable for the level n+1 and level n managers to examine the resulting weights and for the level n+1 manager to request comments by level n manager on the initial relative intra-set weights of each T-value function associated with the reporting group. The initial relative intra-set weights may then be adjusted based on these comments to determine a final set of relative intra-set weights for the T-value functions. This process may be iterative.

Once the relative intra-set weights are determined, each T-value function in the set of T-value functions by its determined relative intra-set weight in step 510. A base composite indicator value associated with the reporting group associated with the set of T-value functions is then calculated using the weighted T-value functions of the set of T-value functions and indicator values of indicators of the reporting group in step 512. Step 512 may be performed using any of the exemplary methods described above with reference to FIGS. 1 and 4. The indicator values used in step 512 may be current indicator values, exemplary indicator values, or time series of either historic or exemplary indicator data. It is determined whether any other reporting groups remain for which initial composite indicator values have not yet been calculated in step 514. Steps 506, 508, 510, and 512 are repeated for each remaining reporting group.

Once base composite indicators have been determined for each reporting group, sensitivity parameters associated with each reporting group are determined, step 516. These sensitivity parameters determine the sensitivity of the level n manager to the reporting group. In the case in which the indicators used to determine the T-value functions are KRI's, the sensitivity parameters may also be considered the acceptable risk level (i.e. the risk appetite) of the level n manager.

Once the sensitivity parameters are determined, the associated composite indicator values are calculated based on the associated base composite indicator value and the associated sensitivity parameters, step 518.

As in the case of determining the relative intra-set weights of the T-value functions associated with the reporting groups, the sensitivity parameters may be determined using an exemplary interview process. In this exemplary interview process, the reporting manager(s) (level n+1) ask their level n manager the following question about several carefully chosen hypothetical situations, “In this situation, would you (a) not wish to have it drawn to your attention, (b) be wish to be kept informed; or (c) wish to become involved.” These hypothetical situations are desirably chosen so as to be characterized by a set of indicator values of the underlying T-values or, where applicable, indicator representations such as KRI representations.

With the relative intra-set weights of the T-value functions previously established, the interview may be relatively short, only including two or three questions to establish values for the sensitivity parameters that reflect the sensitivity to the reporting group, or associated risk appetite, that the level n manager has. It may also reflect the confidence of the level n manager in the level n+1 manager in question. This is because, in general, level n managers have less desire to have intermediate range issues brought to their attention when they have greater confidence in their subordinates (and/or a larger risk appetite).

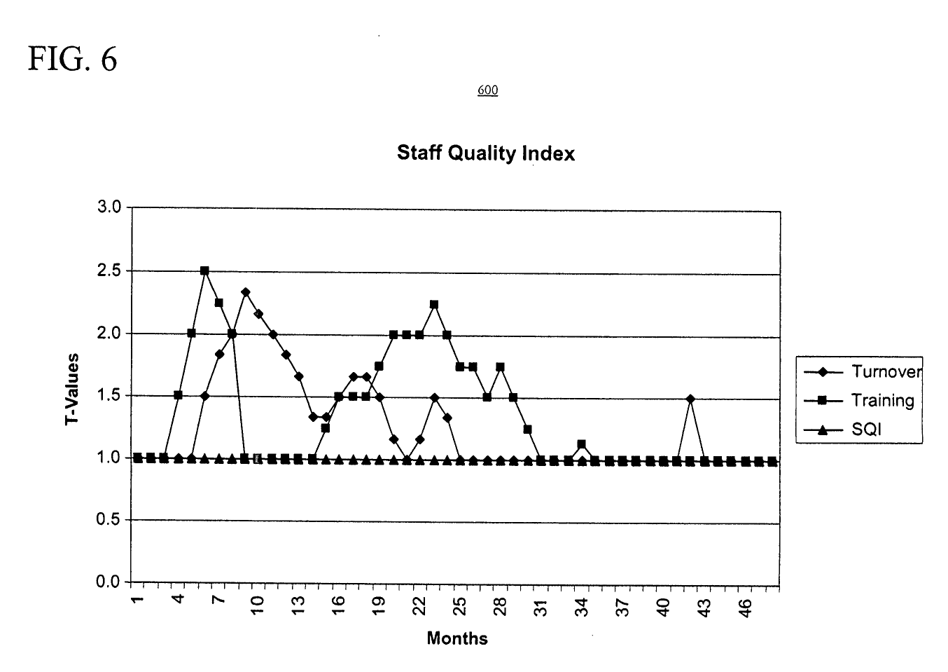

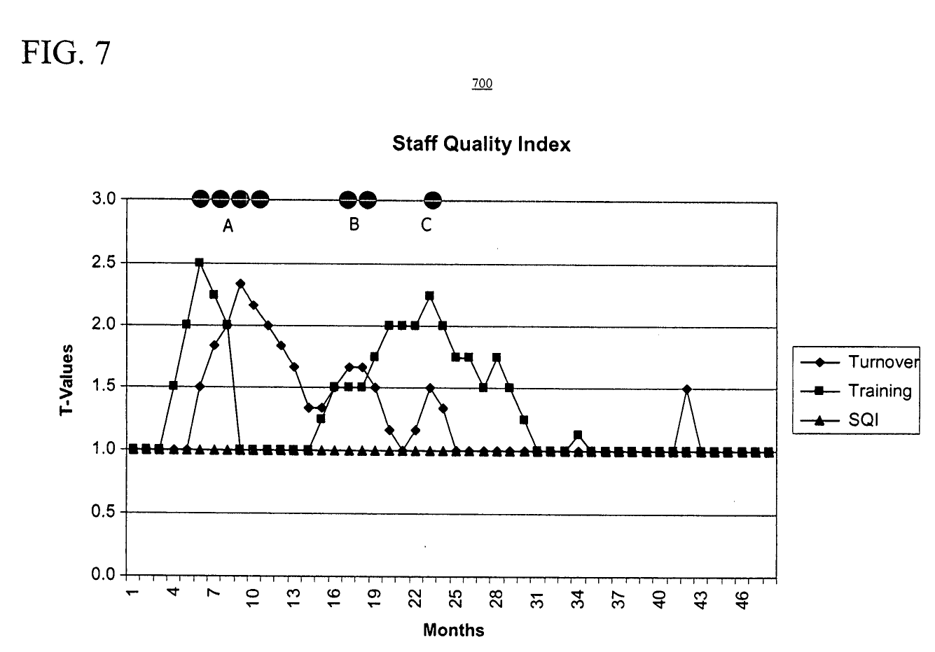

As an example of how these sensitivity parameters may be determined, consider the case of a composite indicator formed from T-value functions associated with two KRI's. The level n+1 manager may start by showing graph 600 of FIG. 6 to the level n manager in their reporting relationship. Graph 600 illustrates time series of T-values of associates with two KRI's, Staff Turnover and Staff Training, over a 48 month period. These series of T-values may be based on actual historical indicator data or the may be series of exemplary data created to illustrate a variety possible combinations of T-values. The exemplary Staff Quality Index (SQI) time series in this figure has a default value of 1 for each month because the sensitivity parameters have not yet been determined.

Together level n+1 manager and the level n manager may review these series of T-values and determine which pairs of monthly data points they believe should be flagged for escalation, i.e. which months the believe that the composite indicator should have a composite indicator value in the undesirable range, greater than or equal to 2 in this example.

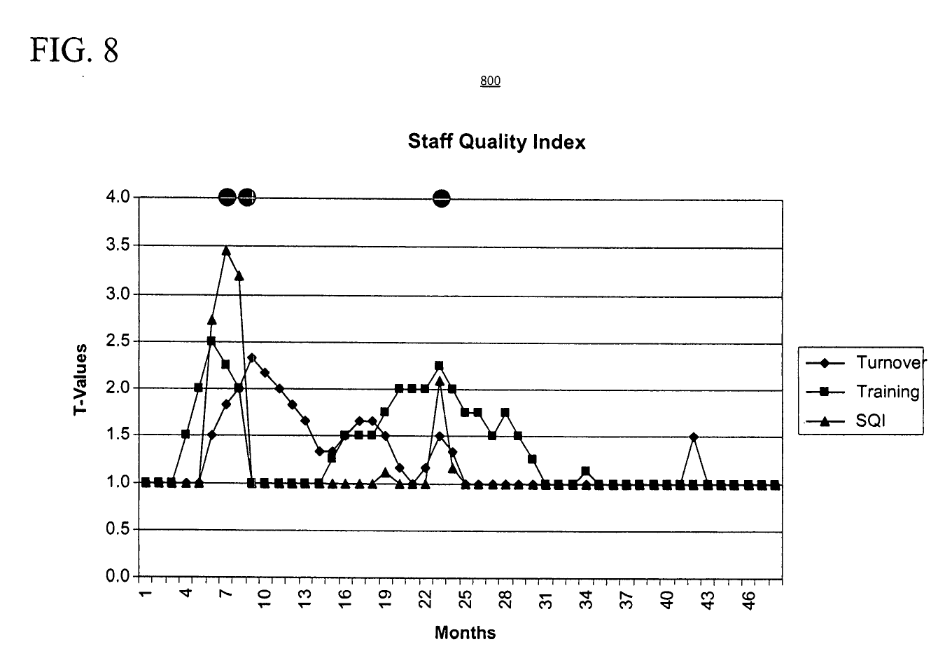

In this example, the level n+1 manager and the level n manager agree that there are seven months in which it would be desirable to escalate the involvement of the level n manager in issues related to the SQI. Graph 700 of FIG. 7 illustrates these seven months, marked by circles in three groups A, B, and C.

FIG. 8 illustrates graph 800 in which an initial attempt has been made to determine sensitivity parameters, a and b, to generate the desired SQI time series. In this exemplary attempt, initial sensitivity parameters of a=0.1 and b=5 have been selected. These values are used to form an initial SQI. A time series of SQI values is then calculated the two T-value time series. As graph 800 shows, this exemplary time series of SQI values only has three months in the undesirable range. Thus, the time series of SQI values calculated using these initial sensitivity parameters results in under-representing the number of month in the undesirable range. Identifying only half of the months from group A and completely failing to identify either month from group B.

The level n+1 manager may request comments from this initial time series of SQI values and try to adjust the initial sensitivity parameters associated with the reporting group based on these comments. With some practice, the managers may become adept at adjusting the sensitivity parameters to achieve the desired time series of SQI values.

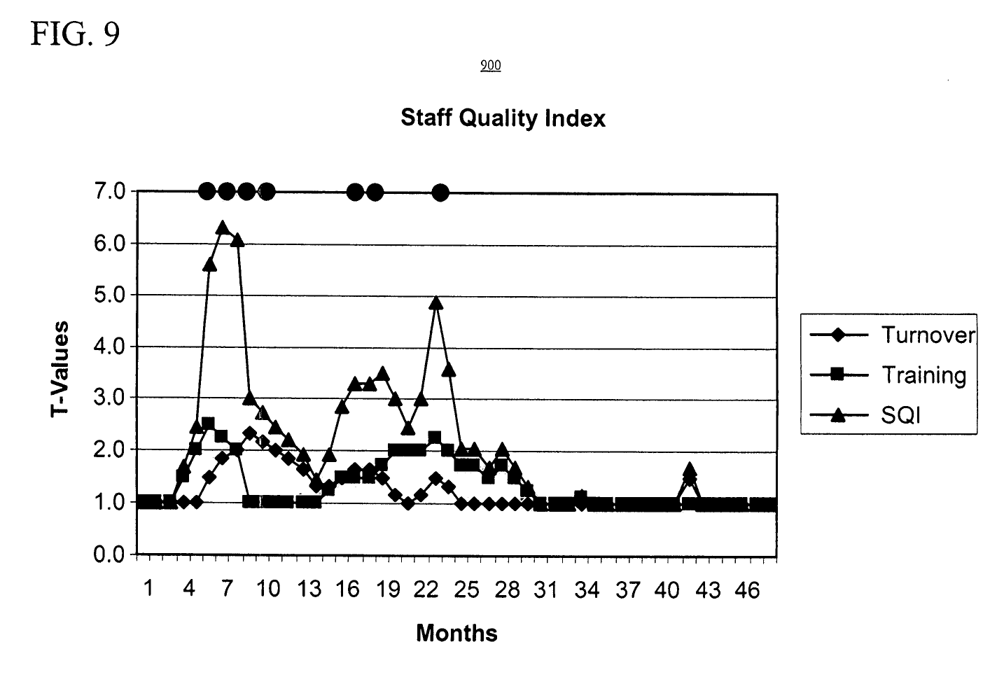

Graph 900 in FIG. 9 illustrates an exemplary time series of SQI values that may be attained after varying the sensitivity parameters in this manner. The sensitivity parameters of the exemplary SQI used to calculate the time series of SQI values in graph 900 are a=1 and b=2.6. As may be seen in FIG. 9, this exemplary time series of SQI values achieve the desired result with the SQI values of all seven of the months identified in FIG. 7 in the undesirable range.

It is noted that this exemplary interview process was described for one level n+1 manager reporting to one level n manager in a reporting relationship. It is contemplated, however, that the same exemplary process may be undertaken by every level n+1 manager in the reporting relationship, thereby completing the establishment of thresholds and parameter values for all composite indicators used in this reporting relationship. Further, this exemplary interview process may be repeated for all reporting relationships in the organization. By repeating this exemplary process for all reporting relationships in the organization, a complete set of consistent thresholds and parameter values for composite indicators may be defined throughout any organization.

Additionally, this interview process may be iterative. The frequency of revision may be a function of changing standards of management over time. Other circumstantial changes such as the hiring or promotion of new people into reporting relationships, new organizational units, new products and so forth, may also impact what higher levels of management desire to be escalated. One skilled in the art may expect thresholds and parameter values to be revised more frequently than the relative intra-set weights of the T-values associated with a reporting group of indicators, and they may also expect those relative intra-set weights to be revisited more frequently than the grouping of indicators into reporting groups.

It is noted that two managers with similar functions and responsibilities in different parts of an organization may develop very different reporting groups, parameter values, thresholds and ranges. This is possible. If a manager at level n was consistently reporting very few red or yellow circumstances vis-à-vis their peers and incurring loss that were no better than average, however, they may expect to have to proffer an explanation to their seniors about why that was the case and, in the absence of a satisfactory explanation, an interview iteration may be required of them. Moreover, with guidelines provided centrally, the main source of variance between ostensibly similar reporting relationships is likely to be the idiosyncratic features of each such relationship, which may be desirable in many circumstances.

Thus, the exemplary interview process of the present invention may serve as a framework for developing a reporting strategy, taking what might otherwise be inchoate discussions of risk or other management issues in different reporting relationships across an organization and making use of these discussions in a practical, coherent and transparent way.

It is contemplated that the exemplary methods described above may be carried out within a general purpose computer system instructed to perform these functions by means of a computer-readable medium. Such computer-readable media include; integrated circuits, memory storage devices, magnetic and optical storage media, as well as audio-frequency, radio frequency, and optical carrier waves. Exemplary general-purpose computer systems may include personal computers, work stations, distributed processing computer networks, and parallel processing computer systems. For example, exemplary embodiments of the present invention may be run on a computer, such a computer running an Intel® Pentium® family processor, using Microsoft® applications, such as Windows® and EXCEL®, for example. Alternatively, special purpose computing circuitry may be employed as a computer to perform some or all of these functions. Such computing circuitry may include separate processors to perform individual steps of the exemplary methods of the present invention, or may use the same processor to perform one or more of the steps. Additionally, a display device, such as a computer monitor; a printer; or a projector, may be used to display results from the present invention.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for determining a composite indicator value associated with a plurality of indicators, each indicator having a plurality of indicator values, the method comprising the steps of:
a) determining a plurality of indicator representations, each indicator representation associated with one of the plurality of indicators and based on the indicator values of the one associated indicator, each indicator representation including: at least one first range of indicator values; at least one second range of indicator values; and at least one third range of indicator values, where:
each first range is contiguous with at least one second range;
each second range is contiguous with one first range and one third range; and
each third range is contiguous with at least one second range;
b) providing a current indicator value for each of the plurality of indicators;
c) establishing a T-value function associated with each indicator representation, each T-value function being a continuous function of the associated indicator having:
a first constant T-value equal to a first range value for indicator values in the at least one first range of the associated indicator representation;
a third T-value for the indicator values in each third range of the associated indicator representation that is equal to or greater than a minimum third range value; and
a second variable T-value for the indicator values in each second range of the associated indicator representation that varies monotonically between the first range value and the minimum third range value;
d) calculating, for each indicator, a current T-value corresponding to the current indicator value of the associated indicator provided in step (b) using the associated T-value function established in step (c); and
e) combining the current T-values to calculate the composite indicator value.

2. The method according to claim 1, wherein:
the composite indicator value is a composite risk indicator value;
the plurality of indicator representations is a plurality of key risk indicator (KRI) representations, each KRI representation indicating an operational risk level associated with one of the plurality of indicators;
the at least one first range is at least one green risk level range;
the at least one second range is at least one yellow risk level range; and
the at least one third range is at least one red risk level range.

3. The method according to claim 2, wherein the plurality of KRI's include at least two of: a best practice/compliance issues raised by external professional bodies indicator; an open complaints from consumer groups, activists, and ombudsman indicator; an open complaints from regulators indicator; a corporate conflicts of interest detected that were not identified in advance indicator; a customer and client compensation cases settled indicator; an ex-gratia payments indicator; an external audit points overdue indicator; an external authority, regulatory, and/or industry alerts received indicator; a fee and charge waivers indicator; a help desk calls from customers indicator; an overdue internal audit points indicator; a breaches of internal information barriers indicator; an overdue investigation items internally indicator; a pending litigation cases indicator; a changes in senior management indicator; a market practice changes in pipeline indicator; an operational loss events indicator; an organizational change indicator; a personal conflicts of interest detected that were not identified in advance indicator; an open physical and information security review and audit issues indicator; a detected policy and control exceptions or failures indicator; a profit and loss write-offs indicator; a regulatory enforcements within the industry indicator; a regulatory investigations indicator; an average number of sick or non-holiday absence days per employee indicator; a staff employment tenure indicator; a staff turnover indicator; a tip-offs received indicator; a substantiated instances of whistle-blowing indicator; a staff training indicator; an inventory indicator; an accounts receivable indicator; an accounts payable indicator; or a staff productivity indicator.

4. The method according to claim 2, further comprising the steps of:
f) comparing the composite risk indicator value calculated in step (e) to a predetermined risk value;
g) reporting the composite risk indicator value to management if the composite risk indicator value is greater than or equal to the predetermined risk value.

5. The method according to claim 1, wherein:
the composite indicator value is a composite performance indicator value;
the plurality of indicator representations is a plurality of key performance indicator (KPI) representation, each KPI representation indicating a performance level associated with one of the plurality of indicators;
the at least one first range is at least one first performance level range;
the at least one second range is at least one second performance level range; and
the at least one third range is at least one third performance level range.

6. The method according to claim 5, wherein the plurality of KPI's include at least two of: an average collection period indicator; an average time for response to a customer inquiry indicator; a chargeable ratio indicator; a current ratio indicator; a customer loyalty indicator; a customer satisfaction indicator; a customer satisfaction survey score; a gross profit margin indicator; an input use per unit of output indicator; a machine planned maintenance downtime indicator; a machine unplanned maintenance downtime indicator; a net labor cost indicator; a number of items processed per employee indicator; a number of rejects per 1000 items processed indicator; a profit before taxes indicator; a return on capital indicator; a revenue growth indicator; a same store sales growth indicator; a yield per hectare indicator; or a z score liquidity indicator.

7. The method according to claim 5, further comprising the steps of:
f) comparing the composite performance indicator value calculated in step (e) to a predetermined performance value;
g) taking remedial action if the composite performance indicator value is greater than or equal to the predetermined performance value.

8. The method according to claim 5, further comprising the steps of:
f) using the composite performance indicator value calculated in step (e) in compensation determinations.

9. The method according to claim 1, wherein:
step (a) further includes separating the plurality of indicators into at least two sets of indicators, such that all indicators of each set of indicators are related to other indicators of that set; and
step (e) includes the steps of:
e1) calculating a weighted product of the current T-values associated with the indicators of each set of indicators to calculate at least two set indicator values;
e2) weighting each of the at least two set indicator values; and
e3) selecting a maximum of the at least two weighted set indicator values to be the composite indicator value.

10. The method according to claim 1, wherein:
step (a) further includes separating the plurality of indicators into at least two sets of indicators, such that all indicators of each set of indicators are related to other indicators of that set; and
step (e) includes the steps of:
e1) calculating a weighted sum of the current T-values associated with the indicators of each set of indicators to calculate at least two set indicator values;
e2) weighting each of the at least two set indicator values; and
e3) selecting a maximum of the at least two weighted set indicator values to be the composite indicator value.

11. The method according to claim 1, wherein the first range value is 1 and the minimum third range value is 2.

12. The method according to claim 1, wherein the T-value function for the indicator values in each second range includes one of: a linear function; a monotonic polynomial function; an exponential function; a logarithmic function; or an arctangent function.

13. The method according to claim 1, wherein the T-value function for the indicator values in each third range is constant.

14. The method according to claim 1, wherein the T-value function is a continuously differentiable function across each boundary between a second range and a contiguous third range.

15. The method according to claim 1, wherein step (e) includes the steps of:
e1) weighting each of the current T-values calculated in step (d) based on a predetermined relative importance of the corresponding indicator; and
e2) combining the weighted current T-values to calculate the composite indicator value.

16. The method according to claim 1, wherein combining the current T-values to calculate the composite indicator value in step (e) is at least one of:
calculating a sum of the current T-values to be the composite indicator value;
calculating a weighted sum of the current T-values to be the composite indicator value;
calculating a product of the current T-values to be the composite indicator value;
calculating a weighted product of the current T-values to be the composite indicator value;
selecting a maximum of the current T-values to be the composite indicator value.

17. A computer readable medium adapted to instruct a general purpose computer to calculate a composite indicator value associated with a plurality of indicators, each indicator having a plurality of indicator values, the method comprising the steps of:
a) determining a plurality of indicator representations, each indicator representation associated with one of the plurality of indicators and based on the indicator values of the one associated indicator, each indicator representation including: at least one first range of indicator values; at least one second range of indicator values; and at least one third range of indicator values, where:
each first range is contiguous with at least one second range;
each second range is contiguous with one first range and one third range; and
each third range is contiguous with at least one second range;
b) providing a current indicator value for each of the plurality of indicators;
c) establishing a T-value function associated with each indicator representation, each T-value function being a continuous function of the associated indicator having:
a first constant T-value equal to a first range value for indicator values in the at least one first range of the associated indicator representation;
a third T-value for the indicator values in each third range of the associated indicator representation that is equal to or greater than a minimum third range value; and
a second variable T-value for the indicator values in each second range of the associated indicator representation that varies monotonically between the first range value and the minimum third range value;
d) calculating, for each indicator, a current T-value corresponding to the current indicator value of the associated indicator provided in step (b) using the associated T-value function established in step (c); and
e) combining the current T-values to calculate the composite indicator value.

18. An apparatus for determining a composite indicator value associated with a plurality of indicators, each indicator having a plurality of indicator values, the apparatus comprising:
indicator input means to input a plurality of indicator representations, each indicator representation associated with one of the plurality of indicators and based on the indicator values of the one associated indicator, each indicator representation including: at least one first range of indicator values; at least one second range of indicator values; and at least one third range of indicator values, where:
each first range is contiguous with at least one second range;
each second range is contiguous with one first range and one third range; and
each third range is contiguous with at least one second range;
current value input means to input a current value for each of the plurality of indicators;
a T-value processor coupled to the indicator input means to establish a T-value function associated with each indicator representation, each T-value function being a continuous function of the associated indicator having:
a first constant T-value equal to a first range value for indicator values in the at least one first range of the associated indicator representation;
a third T-value for the indicator values in each third range of the associated indicator representation that is equal to or greater than a minimum third range value; and
a second variable T-value for the indicator values in each second range of the associated indicator representation that varies monotonically between the first range value and the minimum third range value;
a calculation processor coupled to the current value input means and the T-value processor to calculate, for each indicator, a current T-value corresponding to the current indicator value of the associated indicator using the current value of the associated indicator and the corresponding T-value function; and
a compositing processor coupled to the calculation processor to combine the current T-values to calculate the composite indicator value.

19. A method for determining a composite indicator value associated with at least a first indicator that has a plurality of first indicator values and a second indicator that has a plurality of second indicator values, the method comprising the steps of:
a) determining a first indicator representation associated with the first indicator and a second indicator representation associated with the second indicator, each of the first indicator representation and the second indicator representation including: at least one first range of indicator values; at least one second range of indicator values; and at least one third range of indicator values, where:
each first range is contiguous with at least one second range;
each second range is contiguous with one first range and one third range; and
each third range is contiguous with at least one second range;
b) providing a current first indicator value and a current second indicator value;
c) establishing a first T-value function associated with the first indicator representation and a second T-value function associated with the second indicator representation, each of the first T-value function and the second T-value function being a continuous function of the associated indicator having:
a first T-value for the indicator values in each first range that is equal to or less than a maximum first range value;
a third T-value for the indicator values in each third range that is equal to or greater than a minimum third range value; and
a second variable T-value for the indicator values in each second range that varies monotonically between the maximum first range value and the minimum third range value;
d) calculating a first current T-value corresponding to the first indicator using the first T-value function and the current first indicator value provided in step (b);
e) calculating a second current T-value corresponding to the second indicator using the second T-value function and the current second indicator value provided in step (b); and
f) calculating the composite indicator value from the first current T-value and the second current T-value, the composite indicator value equal to:
a maximum of a weighted first current T-value and a weighted second current T-value, when the first indicator and the second indicator are unrelated; or
a weighted product of the first current T-value and the second current T-value, otherwise.

20. The method according to claim 19, wherein:
the composite indicator value is a composite risk indicator value;
the first indicator representation is a first key risk indicator (KRI) representation indicating an operational risk level associated with the first indicator;
the second indicator representation is a second KRI representation indicating an operational risk level associated with the second indicator;
the at least one first range is at least one green risk level range;
the at least one second range is at least one yellow risk level range; and
the at least one third range is at least one red risk level range.

21. The method according to claim 20, wherein:
the first KRI is one of: a best practice/compliance issues raised by external professional bodies indicator; an open complaints from consumer groups, activists, and ombudsman indicator; an open complaints from regulators indicator; a corporate conflicts of interest detected that were not identified in advance indicator; a customer and client compensation cases settled indicator; an ex-gratia payments indicator; an external audit points overdue indicator; an external authority, regulatory, and/or industry alerts received indicator; a fee and charge waivers indicator; a help desk calls from customers indicator; an overdue internal audit points indicator; a breaches of internal information barriers indicator; an overdue investigation items internally indicator; a pending litigation cases indicator; a changes in senior management indicator; a market practice changes in pipeline indicator; an operational loss events indicator; an organizational change indicator; a personal conflicts of interest detected that were not identified in advance indicator; an open physical and information security review and audit issues indicator; a detected policy and control exceptions or failures indicator; a profit and loss write-offs indicator; a regulatory enforcements within the industry indicator; a regulatory investigations indicator; an average number of sick or non-holiday absence days per employee indicator; a staff employment tenure indicator; a staff turnover indicator; a tip-offs received indicator; a substantiated instances of whistle-blowing indicator; a staff training indicator; an inventory indicator; an accounts receivable indicator; an accounts payable indicator; or a staff productivity indicator; and
the second KRI is one of: a best practice/compliance issues raised by external professional bodies indicator; an open complaints from consumer groups, activists, and ombudsman indicator; an open complaints from regulators indicator; a corporate conflicts of interest detected that were not identified in advance indicator; a customer and client compensation cases settled indicator; an ex-gratia payments indicator; an external audit points overdue indicator; an external authority, regulatory, and/or industry alerts received indicator; a fee and charge waivers indicator; a help desk calls from customers indicator; an overdue internal audit points indicator; a breaches of internal information barriers indicator; an overdue investigation items internally indicator; a pending litigation cases indicator; a changes in senior management indicator; a market practice changes in pipeline indicator; an operational loss events indicator; an organizational change indicator; a personal conflicts of interest detected that were not identified in advance indicator; an open physical and information security review and audit issues indicator; a detected policy and control exceptions or failures indicator; a profit and loss write-offs indicator; a regulatory enforcements within the industry indicator; a regulatory investigations indicator; an average number of sick or non-holiday absence days per employee indicator; a staff employment tenure indicator; a staff turnover indicator; a tip-offs received indicator; a substantiated instances of whistle-blowing indicator; a staff training indicator; an inventory indicator; an accounts receivable indicator; an accounts payable indicator; or a staff productivity indicator.

22. The method according to claim 20, further comprising the steps of:
g) comparing the composite risk indicator value calculated in step (f) to a predetermined risk value;
h) reporting the composite risk indicator value to management if the composite risk indicator value is greater than or equal to the predetermined risk value.

23. The method according to claim 19, wherein:
the composite indicator value is a composite performance indicator value;
the first indicator representation is a first key performance indicator (KPI) representation indicating a performance level associated with the first indicator;
the second indicator representation is a second KPI representation indicating performance level associated with the second indicator;
the at least one first range is at least one first performance level range;
the at least one second range is at least one second performance level range; and
the at least one third range is at least one third performance level range.

24. The method according to claim 23, wherein:
the first KPI is one of: an average collection period indicator; an average time for response to a customer inquiry indicator; a chargeable ratio indicator; a current ratio indicator; a customer loyalty indicator; a customer satisfaction indicator; a customer satisfaction survey score; a gross profit margin indicator; an input use per unit of output indicator; a machine planned maintenance downtime indicator; a machine unplanned maintenance downtime indicator; a net labor cost indicator; a number of items processed per employee indicator; a number of rejects per 1000 items processed indicator; a profit before taxes indicator; a return on capital indicator; a revenue growth indicator; a same store sales growth indicator; a yield per hectare indicator; or a z score liquidity indicator; and
the second KPI is one of: an average collection period indicator; an average time for response to a customer inquiry indicator; a chargeable ratio indicator; a current ratio indicator; a customer loyalty indicator; a customer satisfaction indicator; a customer satisfaction survey score; a gross profit margin indicator; an input use per unit of output indicator; a machine planned maintenance downtime indicator; a machine unplanned maintenance downtime indicator; a net labor cost indicator; a number of items processed per employee indicator; a number of rejects per 1000 items processed indicator; a profit before taxes indicator; a return on capital indicator; a revenue growth indicator; a same store sales growth indicator; a yield per hectare indicator; or a z score liquidity indicator.

25. The method according to claim 23, further comprising the steps of:
g) comparing the composite performance indicator value calculated in step (f) to a predetermined performance value;
h) taking remedial action if the composite performance indicator value is greater than or equal to the predetermined performance value.

26. The method according to claim 23, further comprising the steps of:
g) using the composite performance indicator value calculated in step (f) in compensation determinations.

27. The method according to claim 19, wherein the maximum first range value is 1 and the minimum third range value is 2.

28. The method according to claim 19, wherein the T-value function for the indicator values in each first range is one of: a constant function or a continuous function having a single minimum.

29. The method according to claim 19, wherein the T-value function is a continuously differentiable function across each boundary between a second range and a contiguous first range.

30. The method according to claim 19, wherein the T-value function for the indicator values in each second range includes one of: a linear function; a monotonic polynomial function; an exponential function; a logarithmic function; or an arctangent function.

31. The method according to claim 19, wherein the T-value function for the indicator values in each third range is constant.

32. The method according to claim 19, wherein the T-value function is a continuously differentiable function across each boundary between a second range and a contiguous third range.

33. A computer readable medium adapted to instruct a general purpose computer to calculate a composite indicator value associated with a first indicator that has a plurality of first indicator values and a second indicator that has a plurality of second indicator values, the method comprising the steps of:
a) determining a first indicator representation associated with the first indicator and a second indicator representation associated with the second indicator, each of the first indicator representation and the second indicator representation including: at least one first range of indicator values; at least one second range of indicator values; and at least one third range of indicator values, where:
each first range is contiguous with at least one second range;
each second range is contiguous with one first range and one third range; and
each third range is contiguous with at least one second range;
b) providing a current first indicator value and a current second indicator value;
c) establishing a first T-value function associated with the first indicator representation and a second T-value function associated with the second indicator representation, each of the first T-value function and the second T-value function being a continuous function of the associated indicator having:
a first T-value for the indicator values in each first range that is equal to or less than a maximum first range value;
a third T-value for the indicator values in each third range that is equal to or greater than a minimum third range value; and
a second variable T-value for the indicator values in each second range that varies monotonically between the maximum first range value and the minimum third range value;
d) calculating a first current T-value corresponding to the first indicator using the first T-value function and the current first indicator value provided in step (b);
e) calculating a second current T-value corresponding to the second indicator using the second T-value function and the current second indicator value provided in step (b); and
f) calculating the composite indicator value from the first current T-value and the second current T-value, the composite indicator value equal to:
a maximum of a weighted first current T-value and a weighted second current T-value, when the first indicator and the second indicator are unrelated; or
a weighted product of the first current T-value and the second current T-value, otherwise.

34. An apparatus for calculating a composite indicator value associated with a first indicator that has a plurality of first indicator values and a second indicator that has a plurality of second indicator values, the apparatus comprising:
indicator input means to input a first indicator representation associated with the first indicator and a second indicator representation associated with the second indicator, each of the first indicator representation and the second indicator representation including: at least one first range of indicator values; at least one second range of indicator values; and at least one third range of indicator values, where:
each first range is contiguous with at least one second range;
each second range is contiguous with one first range and one third range; and
each third range is contiguous with at least one second range;
current value input means to input a current first indicator value and a current second indicator value;
a T-value processor coupled to the indicator input means to establish a first T-value function associated with the first indicator representation and a second T-value function associated with the second indicator representation, each of the first T-value function and the second T-value function being a continuous function of the associated indicator having:
a first T-value for the indicator values in each first range that is equal to or less than a maximum first range value;
a third T-value for the indicator values in each third range that is equal to or greater than a minimum third range value; and
a second variable T-value for the indicator values in each second range that varies monotonically between the maximum first range value and the minimum third range value;
a calculation processor coupled to the current value input means and the T-value processor to calculate:
a first current T-value corresponding to the first indicator using the first T-value function and the current first indicator value; and
a second current T-value corresponding to the second indicator using the second T-value function and the current second indicator value; and
a compositing processor coupled to the calculation processor to calculate the composite indicator value from the first current T-value and the second current T-value, the composite indicator value equal to:
a maximum of a weighted first current T-value and a weighted second current T-value, when the first indicator and the second indicator are unrelated; or
a weighted product of the first current T-value and the second current T-value, otherwise.

35. A method of forming one or more composite indicator values for reporting on a plurality of indicators of an organization, the method comprising the steps of:
a) establishing a plurality of T-value functions, each T-value function associated with one of the plurality of indicators;
b) determining one or more reporting groups of the plurality of indicators, each reporting group associated with one of the composite indicators;
c) designating one or more sets of T-value functions from the plurality of T-value functions, each set of T-value functions including T-value functions associated with one reporting group of indicators;
d) for each set of T-value functions:
determining a relative intra-set weight of each T-value function in the set of T-value functions;
weighting each T-value function in the set of T-value functions by its determined relative intra-set weight; and
calculating a base composite indicator value associated with the reporting group associated with the set of T-value functions using the weighted T-value functions of the set of T-value functions and indicator values of indicators of the reporting group;
e) determining sensitivity parameters associated with each reporting group; and
f) for each reporting group, calculating the composite indicator value based on the associated base composite indicator value and the associated sensitivity parameters.

36. The method according to claim 35, wherein step (a) includes the steps of:
a1) determining a plurality of indicator representations, each indicator representation associated with one of the plurality of indicators and based on the indicator values of the one associated indicator, each indicator representation including: at least one first range of indicator values; at least one second range of indicator values; and at least one third range of indicator values, where:
each first range is contiguous with at least one second range;
each second range is contiguous with one first range and one third range; and
each third range is contiguous with at least one second range; and
a2) establishing a T-value function associated with each indicator representation, each T-value function being a continuous function of the associated indicator having:
a first T-value equal to or less than a maximum first range value for the indicator values in the at least one first range;
a third T-value for the indicator values in each third range that is equal to or greater than a minimum third range value; and
a second variable T-value for the indicator values in each second range that varies monotonically between the maximum first range value and the minimum third range value.

37. The method according to claim 35, wherein determining the relative intra-set weight of each T-value function in the set of T-value functions in step (d) includes the steps of:
determining an intra-set ranking of each T-value function in the set of T-value functions;
determining subsets of related T-value functions within the set of T-value functions;
determining a related subset correction factor for each subset of related T-value functions; and
determining a relative intra-set weight of each T-value function in the set of T-value functions based on:
the intra-set ranking of the T-value function; and
if the T-value function is in a subset of related T-value functions, the related subset correction factor of the subset of related T-value functions.

38. The method according to claim 37, wherein:
determining the intra-set ranking of each T-value function in the set of T-value functions in step (d) includes determining a subset of key T-value functions; and
determining a relative intra-set weight of each T-value function in the set of T-value functions in step (d) is based on:
the intra-set ranking of the T-value function;
if the T-value function is in the subset of key T-value functions, a key subset bonus factor; and
if the T-value function is in a subset of related T-value functions, the subset correction factor of the subset of related T-value functions.

39. The method according to claim 38, wherein the key subset bonus factor is equal to a number of T-value functions in the set of T-value functions.

40. The method according to claim 37, wherein determining the related subset correction factor of a subset of related T-value functions in step (d) includes the steps of:
determining an initial intra-set weight of each T-value function of the subset of related T-value functions based on the intra-set ranking of the T-value function;
determining a minimum initial intra-set weight of the T-value functions of the subset of related T-value functions;
setting the related subset correction factor of the subset of related T-value functions to be ½ of the minimum initial intra-set weight of the T-value functions of the subset of related T-value functions.

41. The method according to claim 37, wherein determining the relative intra-set weight of each T-value function in the set of T-value functions in step (d) includes:
determining an initial relative intra-set weight of each T-value function to be equal to a number of T-value functions in the set of T-value functions minus the intra-set ranking of the T-value function in the set of T-value functions; and
determining the relative intra-set weight of each T-value function in the set of T-value functions to be equal to:
if the T-value function is in a subset of related T-value functions, the initial relative intra-set weight of the T-value function minus the subset correction factor of the subset of related T-value functions; and
the initial relative intra-set weight of the T-value function, otherwise.

42. The method according to claim 37, wherein determining the relative intra-set weight of each T-value function in the set of T-value functions in step (d) includes:
determining an initial relative intra-set weight of each T-value function based on:
the intra-set ranking of the T-value function; and
if the T-value function is in a subset of related T-value functions, the related subset correction factor of the subset of related T-value functions;
requesting comments by a user on the initial relative intra-set weight of each T-value function; and
adjusting the initial relative intra-set weight of each T-value function in the set of T-value functions to determine the relative intra-set weight of each T-value function based on the comments of the user.

43. The method according to claim 37, wherein forming the base composite indicator associated with the reporting group associated with the set of T-value functions in step (d) includes at least one of:
calculating the base composite indicator value associated with the reporting group associated with the set of T-value functions using a weighted sum of T-values calculated from the set of T-value functions and indicator values of indicators of the reporting group; or
calculating the base composite indicator value associated with the reporting group associated with the set of T-value functions using a weighted product of T-values calculated from the set of T-value functions and indicator values of indicators of the reporting group.

44. The method according to claim 35, wherein step (e) includes, for each reporting group, the steps of:
e1) determining initial sensitivity parameters associated with the reporting group;
e2) providing a time series of test indicator values corresponding to each indicator associated with the reporting group;
e3) calculating a time series of composite indicator values based on the time series of test indicator values provided in step (e3) using the set of T-value functions associated with the reporting group and the relative intra-set weight of each T-value function in the set of T-value functions determined in step (d);
e5) requesting comments by a user on the initial sensitivity parameters associated with the reporting group based on the time series of composite indicator values for the reporting group;
e6) adjusting the initial sensitivity parameters associated with the reporting group based on the comments of the user;
e7) repeating steps (e3), (e4), (e5), and (e6), until the user is satisfied with the time series of composite indicator values for the reporting group; and
e8) determining the last initial sensitivity parameters to be the sensitivity parameters associated with the reporting group.

45. A computer readable medium adapted to instruct a general purpose computer to calculate one or more composite indicator values for reporting on a plurality of indicators of an organization, the method comprising the steps of:
a) establishing a plurality of T-value functions, each T-value function associated with one of the plurality of indicators;
b) determining one or more reporting groups of the plurality of indicators, each reporting group associated with one of the composite indicators;
c) designating one or more sets of T-value functions from the plurality of T-value functions, each set of T-value functions including T-value functions associated with one reporting group of indicators;
d) for each set of T-value functions:
determining a relative intra-set weight of each T-value function in the set of T-value functions;
weighting each T-value function in the set of T-value functions by its determined relative intra-set weight; and
calculating a base composite indicator value associated with the reporting group associated with the set of T-value functions using the weighted T-value functions of the set of T-value functions and indicator values of indicators of the reporting group;
e) determining sensitivity parameters associated with each reporting group; and
f) for each reporting group, calculating the composite indicator value based on the associated base composite indicator value and the associated sensitivity parameters.
